(19) United States
(12) Patent Application Publication
(10) Pub. No.: US 2025/0367559 A1
(43) Pub. Date: Dec. 4, 2025

(54) ANIMATION GENERATION METHOD AND APPARATUS, MOTION CONTROLLER TRAINING METHOD AND APPARATUS, AND DEVICE

(71) Applicant: Tencent Technology (Shenzhen) Company Limited, Shenzhen (CN)

(72) Inventor: Shidi LI, Shenzhen (CN)

(21) Appl. No.: 19/303,273

(22) Filed: Aug. 18, 2025

Related U.S. Application Data
(63) Continuation of application No. PCT/CN2024/102623, filed on Jun. 28, 2024.

(30) Foreign Application Priority Data
Sep. 4, 2023 (CN) 202311130806.8

(51) Int. Cl. A63F 13/57; A63F 13/52; G06T 7/246; G06T 7/73; G06T 13/40

(52) U.S. Cl. CPC A63F 13/57; A63F 13/52; G06T 7/246; G06T 7/73; G06T 13/40

(57) ABSTRACT

Provided is an animation generation method performed by a computer device. The method includes: obtaining target information and a first pose of a virtual character in a first picture; processing the target information and the first pose through a motion controller when the virtual character is in a stand-up state, to obtain motion information of the virtual character; simulating a stand-up motion of the virtual character based on the motion information and the first pose, to obtain a second pose of the virtual character; and displaying the second pose of the virtual character in the second picture, to present a stand-up animation of the virtual character. The technical method can generate a pose of a virtual character in a next picture frame in real time, thereby improving accuracy and realism of a pose transition, that is, enabling a more accurate and realistic stand-up animation effect.

### CROSS-REFERENCE TO RELATED APPLICATIONS

This application is a continuation application of PCT Patent Application No. PCT/CN2024/102623, entitled “ANIMATION GENERATION METHOD AND APPARATUS, MOTION CONTROLLER TRAINING METHOD AND APPARATUS, AND DEVICE” filed on Jun. 28, 2024, which claims priority to Chinese Patent Application No. 202311130806.8, entitled “ANIMATION GENERATION METHOD AND APPARATUS, MOTION CONTROLLER TRAINING METHOD AND APPARATUS, AND DEVICE” filed with the China National Intellectual Property Administration on Sep. 4, 2023, both of which are incorporated herein by reference in their entirety.

### FIELD OF THE TECHNOLOGY

This application relates to the field of computer technologies, and in particular, to an animation generation method and apparatus, and a motion controller training method and apparatus, and a device.

### BACKGROUND OF THE DISCLOSURE

A scene where virtual characters are knocked down and then push themselves back to stand is common in games. Players expect the motions of the virtual characters in this knockdown-to-stand-up scene to be both smooth and diverse. Therefore, how to generate a high-quality stand-up animation is a research focus in this field.

### SUMMARY

Embodiments of this application provide an animation generation method and apparatus, a motion controller training method and apparatus, and a device, to generate a pose of a virtual character in a next picture frame in real time, thereby improving accuracy and realism of a pose transition, that is, enabling a more accurate and realistic effect of a stand-up animation. The technical solutions are as follows.

According to one aspect, an animation generation method is performed by a computer device and the method includes: obtaining target information and a first pose of a virtual character in a first picture, the target information comprising an operation on the virtual character and a motion state of the virtual character; processing the target information and the first pose through a motion controller when the virtual character is in a stand-up state, to obtain motion information of the virtual character, the motion controller being configured to determine subsequent motions of the virtual character; simulating stand-up motion of the virtual character based on the motion information and the first pose, to obtain a second pose of the virtual character; and animating the stand-up motion of the virtual character by displaying the second pose of the virtual character in the second picture after the first picture.

According to another aspect, a computer device is provided. The computer device includes a processor and a memory, the memory being configured to store at least one computer program, the at least one computer program being executed by the processor and causing the computer device to implement the animation generation method or the motion controller training method in the embodiments of this application.

According to another aspect, a non-transitory computer-readable storage medium is provided. The computer readable storage medium has at least one computer program stored therein, the at least one computer program being loaded and executed by a processor of a computer device and causing the computer device to implement the animation generation method or the motion controller training method in the embodiments of this application.

According to the animation generation method provided in the embodiments of this application, a pose of a virtual character in a current picture, an operation on the virtual character, and a motion state of the virtual character are inputted into a motion controller for processing, so that the motion controller applies an impact of an operation of an object based on the current pose and the motion state of the virtual character, to more accurately calculate motion information of the virtual character to align with the intent of the object. Then, a stand-up motion of the virtual character is simulated based on the motion information and the first pose of the virtual character, enabling pose transitions of the virtual character to conform to the laws of motion, that is, making the pose transitions of the virtual character more realistic. In addition, the pose of the virtual character can be transitioned based on the guidance of the motion information, and a pose of the virtual character in a next picture frame is generated in real time, thereby improving accuracy and realism of the pose transition, that is, enabling a more accurate and realistic effect of the stand-up animation.

### BRIEF DESCRIPTION OF THE DRAWINGS

FIG. 1 is a schematic diagram of an implementation environment of an animation generation method according to an embodiment of this application.

FIG. 2 is a flowchart of an animation generation method according to an embodiment of this application.

FIG. 3 is a flowchart of another animation generation method according to an embodiment of this application.

FIG. 4 is a flowchart of a method for determining a motion state according to an embodiment of this application.

FIG. 5 is a schematic diagram of a model of a virtual character according to an embodiment of this application.

FIG. 6 is a schematic diagram of generating a stand-up animation according to an embodiment of this application.

FIG. 7 is a flowchart of a motion controller training method according to an embodiment of this application.

FIG. 8 is a flowchart of another motion controller training method according to an embodiment of this application.

FIG. 9 shows a motion controller training method according to an embodiment of this application.

FIG. 10 is a block diagram of an animation generation apparatus according to an embodiment of this application.

FIG. 11 is a block diagram of another animation generation apparatus according to an embodiment of this application.

FIG. 12 is a block diagram of a motion controller training apparatus according to an embodiment of this application.

FIG. 13 is a block diagram of another motion controller training apparatus according to an embodiment of this application.

FIG. 14 is a structural block diagram of a terminal according to an embodiment of this application.

FIG. 15 is a schematic structural diagram of a server according to an embodiment of this application.

### DESCRIPTION OF EMBODIMENTS

In this application, terms such as “first” and “second” are used to distinguish between same items or similar items with substantially a same role and function. There is no logical or time sequential dependence between “first”, “second”, and “n^{th}”, and a number and an execution order are not limited.

In this application, the term “at least one” refers to one or more, and “a plurality of” refers to two or more.

All information (including, but not limited to, user equipment information, user personal information, and the like), data (including, but not limited to, data configured for analysis, stored data, displayed data, and the like), and a signal involved in this application are authorized by a user or fully authorized by all parties, and the collection, use, and processing of relevant data need to comply with the related laws, regulations, and standards of related countries and regions. For example, a pose and target information involved in this application are both obtained with sufficient authorization.

In the related art, three fixed animations are usually stored in a resource library first: a walking/running animation, a supine-to-stand animation, and a prone-to-stand animation. Under normal circumstances, when a virtual character is in a normal walking/running state, the walking/running animation is simply looped. When it is determined that the virtual character is about to be knocked down, a knockdown animation of the virtual character is physically simulated through a RagDoll system. When it is determined that the virtual character is lying on the ground, a current pose of the virtual character is smoothly transitioned to the first frame of the supine-to-stand animation or the prone-to-stand animation based on a body orientation of the virtual character. Then, a corresponding animation clip is played to complete the stand-up motion, followed by a continuous loop of the walking/running animation.

However, in the foregoing technical solution, determining when to activate the RagDoll system not only involves a heavy workload but also lacks accuracy. For example, the virtual character is about to be hit by a vehicle, it is necessary to perform determining before the collision occurs and switch the animation to the RagDoll system. If the switching is delayed excessively, the virtual character in this case is in a mode of playing the walking/running animation without physical simulation features. As a result, even after the collision, the virtual character will not react, and the vehicle is instead bounced away. Such a result is clearly unacceptable. If the switching is made prematurely, due to the lack of intrinsic torque generation in the character's joints in the RagDoll system, the virtual character will become limp and start falling down before the collision actually occurs. Therefore, the foregoing determining mechanism requires developers to write and fine-tune each discrimination condition and determining timing, which involves a heavy workload and lacks accuracy, leading to a poor animation effect.

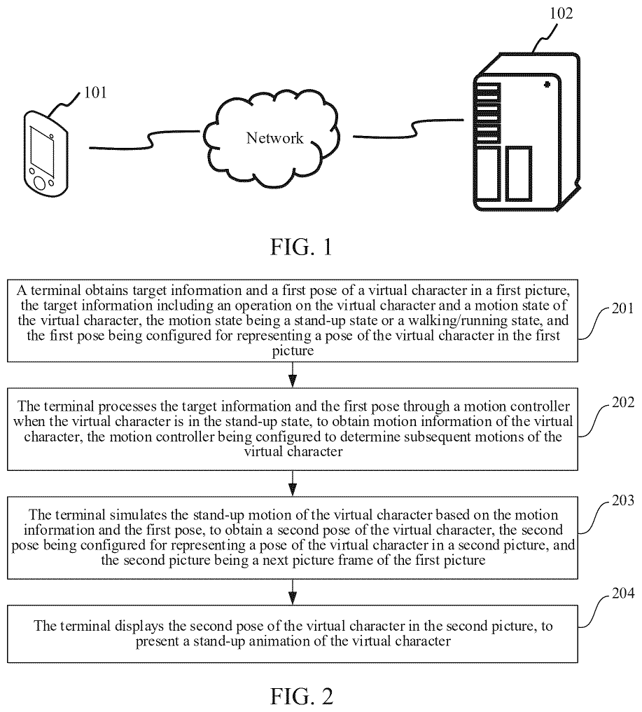

An animation generation method and a motion controller training method provided in the embodiments of this application can be performed by a computer device. In some embodiments, the computer device is a terminal or a server. An implementation environment of an animation generation method provided in the embodiments of this application is first described below by using an example in which the computer device is a terminal. FIG. 1 is a schematic diagram of an implementation environment of an animation generation method according to an embodiment of this application. Referring to FIG. 1, the implementation environment includes a terminal 101 and a server 102. The terminal 101 and the server 102 can be connected directly or indirectly in a wired or wireless communication manner. This is not limited in this application.

In some embodiments, the terminal 101 is a smartphone, a tablet computer, a notebook computer, a desktop computer, a smart speaker, a smartwatch, an intelligent voice interaction device, an intelligent appliance, an in-vehicle terminal, or the like, but is not limited thereto. An application supporting a virtual scene is installed and run on the terminal 101. The application may be any one of a first-person shooting game (FPS), a third-person shooting game, a multiplayer online battle arena (MOBA) game, a virtual reality application, a three-dimensional map application, or a multiplayer gunfight survival game. For example, the terminal 101 is a terminal used by a user. The user uses the terminal 101 to operates a virtual character in a virtual scene to perform an activity. The activity includes, but is not limited to, at least one of adjusting a body posture, crawling, walking, running, riding, jumping, driving, picking up, shooting, attacking, and throwing. For example, the virtual character is a virtual person, for example, a simulated character role or an animation character role. When the virtual character falls down, the terminal 101 may simulate a stand-up motion of the virtual character through a motion controller based on an operation on the virtual character and an impact applied to the virtual character in a virtual environment, to form a stand-up animation.

A person skilled in the art may learn that there may be more or fewer terminals. For example, there may be only one terminal, or there may be dozens or hundreds of terminals, or more terminals. A number and a device type of the terminals are not limited in this embodiment of this application.

In some embodiments, the server 102 is an independent physical server, or can be a server cluster or a distributed system including a plurality of physical servers, or can alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The server 102 is configured to provide a backend service for an application supporting the virtual scene. In some embodiments, the server 102 undertakes primary computing work, and the terminal 101 undertakes secondary computing work; or the server 102 undertakes secondary computing work, and the terminal 101 undertakes primary computing work; or a distributed computing architecture is used between the server 102 and the terminal 101 to perform collaborative computing.

In some embodiments, the server 102 may further train the motion controller to enable the motion simulated by the terminal 101 through the motion controller to be more realistic. Accordingly, the server 102 may train the motion controller through the motion controller training method provided in this embodiment of this application. After the training, the server 102 may deliver parameters of the motion controller to the terminal 101, so that the terminal 101 generates the stand-up animation of the virtual character based on the trained motion controller. In other words, an implementation environment of the motion controller training method is the same as the implementation environment of the animation generation method. Details are not described herein again.

FIG. 2 is a flowchart of an animation generation method according to an embodiment of this application. Referring to FIG. 2, this embodiment of this application is described by using an example in which the method is performed by a terminal. The method includes the following operations.

201: A terminal obtains target information and a first pose of a virtual character in a first picture, the target information including an operation on the virtual character and a motion state of the virtual character, the motion state being a stand-up state or a walking/running state, and the first pose being configured for representing a pose of the virtual character in the first picture.

In this embodiment of this application, the terminal displays the first picture. The first picture displays the virtual character in the first pose. A specific form of the first pose is not limited in this embodiment of this application. For example, the first picture includes the virtual character in the first pose and a virtual scene in which the virtual character is located. The operation included in the target information is an operation performed by an object on the virtual character, and the object refers to a user that controls the terminal. The operation is configured for controlling the virtual character to perform an activity, and the object may control the terminal to perform an operation on the virtual character, to control the virtual character to perform an activity. The “activity” may be walking, running, standing up, or the like. This is not limited in this embodiment of this application. The terminal obtains the operation of the object on the virtual character in the first picture, the motion state of the virtual character in the first picture, and the first pose of the virtual character in the first picture. Then, the terminal determines the target information of the virtual character based on the operation performed by the object on the virtual character and the motion state of the virtual character.

In this embodiment of this application, the motion state is one of a plurality of stand-up progresses of the stand-up state or the walking/running state, meaning that the motion state is the stand-up state or the walking/running state, or the motion state is any one of the plurality of stand-up progresses or the walking/running state. The plurality of stand-up progresses of the stand-up state refer to progresses in a stand-up process of the virtual character from lying down to standing, that is, a display progress of a stand-up animation. In this embodiment of this application, the stand-up state includes the plurality of stand-up progresses, and when the motion state of the virtual character is any stand-up progress, the motion state of the virtual character is the stand-up state.

202: The terminal processes the target information and the first pose through a motion controller when the virtual character is in the stand-up state, to obtain motion information of the virtual character, the motion controller being configured to determine subsequent motions of the virtual character.

In this embodiment of this application, when the virtual character is in the stand-up state, or when the virtual character is in any stand-up progress of the stand-up state, the terminal can input the target information and the first pose of the virtual character into the motion controller as input information for processing, to determine the subsequent motions of the virtual character. The subsequent motions of the virtual character are motions of the virtual character in pictures following the first picture. The motion controller may be a neural network. A structure of the motion controller is not limited in this embodiment of this application. The terminal outputs the motion information of the virtual character through the motion controller. The motion information is configured for representing the motion of the virtual character in the picture following the first picture, and is also configured for representing an internal torque applied to the virtual character by the operation of the object, that is, the motion information can reflect an impact of the subsequent motions of the object on the virtual character.

203: The terminal simulates the stand-up motion of the virtual character based on the motion information and the first pose, to obtain a second pose of the virtual character, the second pose being configured for representing a pose of the virtual character in a second picture, and the second picture being a next picture frame of the first picture.

In this embodiment of this application, the terminal simulates the stand-up motion of the virtual character based on the motion information and the first pose by using dynamics knowledge in the field of physics. In other words, the terminal calculates the motion information and the first pose of the virtual character based on dynamics knowledge in the field of physics, to determine a motion trajectory of the subsequent motions of the virtual character. Then, the terminal may determine the second pose of the virtual character based on the first pose and the motion trajectory of the subsequent motions. The second pose is a pose of the virtual character in the next picture frame of the first picture.

204: The terminal displays the second pose of the virtual character in the second picture, to present a stand-up animation of the virtual character.

In this embodiment of this application, the terminal displays the second picture after determining the pose of the virtual character in the next picture frame. The second picture displays the virtual character in the second pose. In other words, as the first picture switches to the second picture, the virtual character transitions from the first pose to the second pose. Accordingly, the pose transition process of the virtual character constitutes the stand-up animation of the virtual character. In this embodiment of this application, after the virtual character falls down, the terminal displays a plurality of consecutive pictures in the foregoing manner, which can reflect the transitions in the pose of the virtual character over time in the stand-up process of the virtual character from lying down to standing, thereby presenting the stand-up animation of the virtual character.

According to the solution of this embodiment of this application, a pose of a virtual character in a current picture, an operation on the virtual character, and a motion state of the virtual character are inputted into a motion controller for processing, so that the motion controller applies an impact of an operation of an object based on the current pose and the motion state of the virtual character, to more accurately calculate motion information of the virtual character, to align with the intent of the object. Then, a stand-up motion of the virtual character is simulated based on the motion information and the first pose of the virtual character, enabling pose transitions of the virtual character to conform to the laws of motion, that is, making the pose transitions of the virtual character more realistic. In addition, the pose of the virtual character can be transitioned based on the guidance of the motion information, and a pose of the virtual character in a next picture frame is generated in real time, thereby improving accuracy and realism of the pose transition, that is, enabling a more accurate and realistic effect of the stand-up animation.

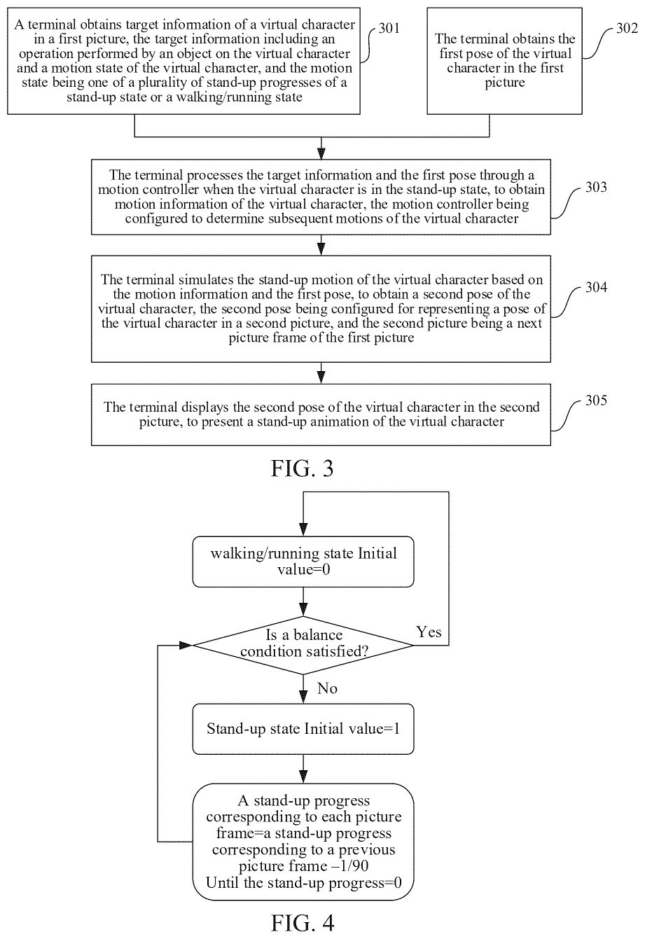

FIG. 3 is a flowchart of another animation generation method according to an embodiment of this application. Referring to FIG. 3, this embodiment of this application is described by using an example in which the method is performed by a terminal. The animation generation method includes the following operations.

301: A terminal obtains target information of a virtual character in a first picture, the target information including an operation performed by an object on the virtual character and a motion state of the virtual character, and the motion state being one of a plurality of stand-up progresses of a stand-up state or a walking/running state.

In this embodiment of this application, the terminal displays the virtual character in the first picture. In some embodiments, the virtual character is a character having two feet. This is not limited in this embodiment of this application. In some embodiments, in the first picture, the virtual character is in the walking/running state or the stand-up state. This is not limited in this embodiment of this application. In some embodiments, the walking/running state is classified as a walking state or a running state. In some embodiments, the stand-up state is divided into a plurality of stand-up progresses. The stand-up progress is a progress of a stand-up animation displayed in a process of the virtual character from lying down to standing up. The terminal obtains the operation performed by the object on the virtual character in the first picture and the motion state of the virtual character. Then, the terminal determines the target information of the virtual character based on the operation performed by the object on the virtual character and the motion state of the virtual character.

In some embodiments, the terminal obtains an expected movement direction and an expected movement speed of the virtual character in response to the operation performed by the object on the virtual character. Then, the terminal determines the motion state of the virtual character in the first picture based on an expected duration of the stand-up animation and the first picture. Then, the terminal determines the target information of the virtual character in the first picture based on the expected movement direction, the expected movement speed, and the motion state. The expected movement direction and the expected movement speed are configured for reflecting a subsequent movement status of the virtual character that is expected by the object. The expected movement direction and the expected movement speed are not limited in this embodiment of this application.

In this embodiment of this application, the operation on the virtual character is configured for controlling movement of the virtual character in a virtual scene, a direction corresponding to the operation is the expected movement direction, and a speed corresponding to the operation is the expected movement speed.

In some embodiments, the object triggers the operation on the virtual character through a virtual control displayed on the terminal. When the virtual control is a draggable control, a dragging direction of the virtual control is the expected movement direction, and a product of a dragging distance of the virtual control and a movement speed corresponding to a unit distance is determined as the expected movement speed. Alternatively, when the virtual control includes a plurality of directional controls, the terminal determines, in response to a trigger operation on at least one directional control, the expected movement direction based on a direction corresponding to the triggered directional control, and determines the expected movement speed based on a movement speed corresponding to the triggered directional control.

In this embodiment of this application, the virtual control is configured to control movement of the virtual character in the virtual scene. When the virtual control is the draggable control, the dragging distance of the virtual control is in positive correlation with an expected movement speed corresponding to a triggered operation, and the movement speed corresponding to the unit distance is a movement speed corresponding to an operation triggered when the virtual control is dragged by the unit distance.

For example, if the first picture displayed by the terminal displays a draggable virtual control, a user triggers a drag operation on the virtual control through the terminal, which is equivalent to the terminal receiving the operation on the virtual character, to determine the expected movement direction and the expected movement speed based on a dragging direction and a dragging distance of the virtual control. In addition, when the user no longer drags the virtual control through the terminal, which is equivalent to the terminal detecting that the drag operation ends, the terminal displays the virtual control at a display position before the virtual control is dragged, so that the virtual control is automatically restored to its original position for display.

In this embodiment of this application, when the virtual control includes a plurality of directional controls, any directional control is configured to control the virtual character to move in a corresponding direction at a corresponding movement speed. Different directional controls correspond to different movement directions, and movement speeds corresponding to different directional controls may be the same or may be different. The trigger operation on the at least one directional control is any type of operation. For example, the trigger operation is a click operation or a swipe operation. The user can control the terminal to simultaneously trigger one or more directional controls. When one directional control is triggered, a direction corresponding to the directional control is determined as the expected movement direction, and a movement speed corresponding to the directional control is determined as the expected movement speed. When the plurality of directional controls are simultaneously triggered, directions corresponding to the plurality of triggered directional controls are combined to obtain the expected movement direction, and a mean or a sum of expected movement speeds corresponding to the plurality of triggered directional controls is determined as the expected movement speed. For example, if a plurality of directional controls including a forward movement control and a right movement control are simultaneously triggered, when the expected movement direction is determined, a direction corresponding to the forward movement control and a direction corresponding to the right movement control are combined, and the combined direction is a direction pointing to the front right, that is, the expected movement direction is a direction pointing to the front right.

In some embodiments, the expected movement direction, the expected movement speed, and the motion state form the target information of the virtual character in the first picture. In this embodiment of this application, the target information includes the expected movement direction, the expected movement speed, and the motion state.

In some embodiments, the target information is a vector. A form of the target information is not limited in this embodiment of this application. For example, a target information g is a four-dimensional vector. The first two dimensions of the target information g are configured for representing the expected movement direction of the virtual character, and are formed by two dimensions of a unit vector on an XY plane, that is, values of the first two dimensions of the target information g are configured for representing the unit vector on the XY plane. The third dimension of the target information g is configured for representing the expected movement speed of the virtual character, for example, the expected movement speed is 260 cm/s. The last dimension of the target information g is configured for representing the motion state of the virtual character. In some embodiment, the motion state is referred to as a phase.

In some embodiments, the terminal presets different values for a plurality of motion states, that is, different values represent different motion states. Accordingly, in a stand-up process of the virtual character, the terminal sequentially replaces the values corresponding to the motion states, to update the motion state. Alternatively, the terminal presets an initial value of the stand-up state and an initial value of the walking/running state, and gradually updates the value corresponding to the motion state of the virtual character from the initial value of the stand-up state to the initial value of the walking/running state based on a number of frames of the stand-up animation, to update the motion state in the stand-up animation. A manner of determining the motion state is not limited in this embodiment of this application.

In some embodiments, the terminal determines the motion state of the virtual character based on the number of frames of the stand-up animation. Accordingly, the process of the terminal determining the motion state of the virtual character in the first picture based on the expected duration of the stand-up animation and the first picture includes: the terminal determining, based on the expected duration of the stand-up animation, a number of frames required to complete the stand-up animation. In addition, the terminal determines a unit progress value corresponding to each picture frame in the stand-up animation based on the number of frames and the initial value of the stand-up state of the virtual character. Then, the terminal determines the motion state of the virtual character in the first picture based on the initial value, the unit progress value, and a time sequence of the first picture in the stand-up animation. The number of frames required to complete the stand-up animation is equivalent to the number of frames corresponding to the stand-up animation. The initial value of the stand-up progress is configured for representing the stand-up state of the virtual character in the first picture frame of the stand-up animation. The unit progress value is configured for representing the magnitude of the stand-up progress updated each displayed picture frame of the stand-up animation, that is, the unit progress value is configured for representing a difference in the stand-up progress of the virtual character between two adjacent picture frames, and the two adjacent picture frames are any two adjacent picture frames in the stand-up animation. The expected duration is any preset duration. For example, the expected duration is three seconds or two seconds. In some embodiments, the expected duration is any duration set by the developers in the development process.

In some embodiments, the terminal determines a product between the expected duration of the stand-up animation and a rendering frame rate of the animation as the number of frames required to complete the stand-up animation. The terminal determines a difference between the stand-up progress and the walking/running state based on a preset initial value of the stand-up progress and a preset initial value of the walking/running state. The difference is configured for representing a process required by the virtual character to restore from the initial stand-up progress to the walking/running state. Then, the terminal determines a ratio of the difference to the number of frames corresponding to the stand-up animation as the unit progress value corresponding to each picture frame in the stand-up animation. The terminal determines a target value corresponding to the first picture based on the time sequence of the first picture in the stand-up animation. The target value is configured for representing a number of pictures between the first picture (the current picture) and the 1^{st} picture (the picture corresponding to the initial value of the stand-up progress) in the stand-up animation. In other words, the target value is configured for representing a position of the first picture in the stand-up animation. Then, the terminal subtracts a first product from the initial value of the stand-up progress, to obtain the value corresponding to the motion state of the virtual character in the first picture, the first product being a product of the unit progress value and the target value. In other words, the motion state of the virtual character in the first picture is equal to the initial value of the stand-up progress minus the unit progress value multiplied by the target value.

The rendering frame rate refers to a number of frames rendered per unit time, that is, a number of pictures rendered per unit time. The difference between the stand-up progress and the walking/running state is a difference between the initial value of the stand-up progress and the initial value of the walking/running state. In some embodiments, the process of determining the target value based on the time sequence includes: determining a difference between the time sequence of the first picture in the stand-up animation and 1 as the target value corresponding to the first picture.

In some embodiments, the terminal further records the motion state of the virtual character in each picture. Accordingly, the terminal subtracts the unit progress value from a value corresponding to a motion state of the virtual character in a previous picture frame of the first picture, to obtain the motion state of the virtual character in the first picture, that is, the value corresponding to the motion state of the virtual character in the previous picture frame minus the unit progress value is the value corresponding to the motion state of the virtual character in the first picture. The initial value of the walking/running state and the initial value of the stand-up progress are not limited in this embodiment of this application. In a process of the virtual character from lying down to standing up, as the virtual character stands up, the value corresponding to the motion state of the virtual character gradually transitions from the initial value of the stand-up progress to the initial value of the walking/running state.

For example, FIG. 4 is a flowchart of a method for determining a motion state according to an embodiment of this application. Referring to FIG. 4, when the virtual character is in a normal walking/running state, the terminal determines that the value corresponding to the motion state of the virtual character is always equal to 0. In this case, 0 is the initial value of the walking/running state. When the virtual character is in the walking/running state, for each picture frame, the terminal invokes determining of a balance condition, to determine whether the virtual character in the current picture satisfies the balance condition. When the virtual character is subjected to a strong impact, such as being hit by a virtual vehicle, the virtual character cannot maintain balance in a real situation, that is, the balance condition of the virtual character is broken. In this case, the terminal determines that the virtual character is in the stand-up state. In other words, the terminal directly transitions the motion state of the virtual character from the walking/running state to the stand-up state. Accordingly, the terminal transitions the value corresponding to the motion state from 0 to 1. In this case, 1 is the initial value of the stand-up state. If the expected duration of the stand-up animation is three seconds, a rendering rate of the animation is a frame rate of 30 frames per second. Therefore, a number of frames required for the stand-up animation is 90 frames. When the virtual character is in the stand-up state, a stand-up progress corresponding to each picture frame is reduced by 1/90. In this way, after 90 frames, the motion state becomes 0 (the walking/running state) again. In this case, the terminal may invoke determining of the balance condition again. If the virtual character satisfies the balance condition, the terminal restores the motion state of the virtual character to the walking/running state, and if the virtual character does not satisfy the balance condition, the terminal re-enters the stand-up state, setting the value corresponding to the motion state to 1 to continue the attempt to stand up.

A determining manner of the balance condition is not limited in this embodiment of this application. In some embodiments, when the virtual character is in the walking/running state, the terminal determines, based on a position and an angle of a pelvis of the virtual character, whether the virtual character satisfies the balance condition. Then, when the virtual character does not satisfy the balance condition, the terminal updates the motion state of the virtual character from the walking/running state to the stand-up state. When the virtual character satisfies the balance condition, the terminal maintains the motion state of the virtual character unchanged as the walking/running state. The balance condition is a condition that needs to be satisfied for the body of the virtual character to maintain balance. In some embodiments, the balance condition indicating a condition that the position and the angle of the pelvis of the virtual character need to satisfy for the body of the virtual character to maintain balance.

For example, the balance condition includes three conditions, that is, a height of the pelvis is greater than 50 cm, a roll angle of the pelvis is less than 45°, and a pitch angle of the pelvis is less than 60°. If the height of the pelvis of the virtual character is greater than 50 cm, the roll angle of the pelvis is less than 45°, and the pitch angle of the pelvis is less than 60°, the terminal determines that the virtual character satisfies the balance condition. The roll angle refers to an angle of tilt of the pelvis of the virtual character in a left/right direction. The pitch angle refers to an angle of tilt of the pelvis of the virtual character in a front/rear direction. If the pelvis of the virtual character does not satisfy any one of the foregoing three conditions, the terminal determines that the virtual character does not satisfy the balance condition.

302: The terminal obtains a first pose of the virtual character in the first picture.

In this embodiment of this application, the terminal obtains angle values of a plurality of rotatable joints on the virtual character. The angle values of the plurality of rotatable joints are configured for reflecting poses of the plurality of rotatable joints. Then, the terminal determines the first pose of the virtual character based on the angle values of the plurality of rotatable joints, a position vector of the pelvis of the virtual character, and a pose vector of the pelvis. Each time the terminal simulates a motion of the virtual character, the terminal records a displacement and a pose quaternion of a base position (component) of the virtual character in a world coordinate system, a displacement and a pose quaternion of the pelvis of the virtual character relative to the base position, and pose quaternions of all rotatable joints involved in the simulation relative to the base position. In this embodiment of this application, the joint may also be referred to as a bone. The base position is configured for reflecting a position of the virtual character in a virtual scene. The base position may be a position of a foot sole of the virtual character, or may be a central position of two feet soles (two feet) of the virtual character. This is not limited in this embodiment of this application.

In some embodiments, the first pose includes the angle values of the plurality of rotatable joints, the position vector of the pelvis of the virtual character, and the pose vector of the pelvis, that is, the angle values of the plurality of rotatable joints, the position vector of the pelvis of the virtual character, and the pose vector of the pelvis form the first pose.

For example, FIG. 5 is a schematic diagram of a model of a virtual character according to an embodiment of this application. Referring to FIG. 5, the virtual character has two feet. The base position (component) of the virtual character is located directly beneath the pelvis of the virtual character, and the base position of the virtual character is located on a plane on which the two feet of the virtual character are located. The terminal calculates rotations of all the rotatable joints involved in dynamics simulation relative to their parent joints, based on the displacement and the pose quaternion of the base position of the virtual character in the world coordinate system, the displacement and the pose quaternion of the pelvis of the virtual character relative to the base position, and the pose quaternions of all the rotatable joints involved in the simulation relative to the base position.

The number and positions of the plurality of rotatable joints are not limited in this embodiment of this application. For example, in addition to the pelvis, the virtual character may further have 18 rotatable joints. For details, refer to Table 1. Each rotatable joint has one or three degrees of freedom. Therefore, it can be known from Table 1 that the 18 rotatable joints may generate a total of 40 degrees of freedom. The terminal may determine 40 angle values based on 18 groups of quaternions representing rotations of the joints relative to the base position. Then, the terminal uses the 40 angle values, along with a pose vector represented by a three-dimensional position vector of the pelvis of the virtual character in the world coordinate system and a six-dimensional forward-up vector, that is, a total of 49-dimensional vectors, to form a feature vector s of the current first pose of the virtual character.

TABLE 1

| | | Degree of | |
|---|---|---|---|
| Joint name | Parent joint | freedom | Rotatable direction |
| Spine_01 | Pelvis | 3 | ZYX |
| Spine_02 | Spine_01 | 3 | ZYX |
| Upperarm_1 | Spine_02 | 3 | ZYX |
| Lowerarm_1 | Upperarm_1 | 1 | Z |
| Hand_1 | Lowerarm_1 | 3 | ZYX |
| Upperarm_r | Spine_02 | 3 | ZYX |
| Lowerarm_r | Upperarm_r | 1 | Z |
| Hand_r | Lowerarm_r | 3 | ZYX |
| Neck | Spine_02 | 1 | Z |
| Head | Neck | 3 | ZYX |
| Thigh_1 | Pelvis | 3 | ZYX |
| Calf_1 | Thigh_1 | 1 | Z |
| Foot_1 | Calf_1 | 3 | ZYX |
| Toe_1 | Foot_1 | 1 | Z |
| Thigh_r | Pelvis | 3 | ZYX |
| Calf_r | Thigh_r | 1 | Z |
| Foot_r | Calf_r | 3 | ZYX |
| Toe_r | Foot_r | 1 | Z |

The timing of the execution of operation 301 and operation 302 is not limited in this embodiment of this application. The terminal may simultaneously perform operation 301 and operation 302, that is, the terminal simultaneously obtains the target information and the first pose of the virtual character in the first picture. Alternatively, the terminal may first perform operation 301 and then perform operation 302, that is, the terminal first obtains the target information of the virtual character in the first picture, and then obtains the first pose of the virtual character. Alternatively, the terminal may first perform operation 302 and then perform operation 301, that is, the terminal first obtains the first pose of the virtual character in the first picture, and then obtains the target information of the virtual character.

303: The terminal processes the target information and the first pose through a motion controller when the virtual character is in the stand-up state, to obtain motion information of the virtual character, the motion controller being configured to determine subsequent motions of the virtual character.

In this embodiment of this application, the motion information is configured for representing an internal torque applied to the virtual character by an operation of an object. When the virtual character is in the stand-up state, the terminal inputs the target information and the first pose of the virtual object into the motion controller, and processes the target information and the first pose through the motion controller, to obtain the motion information of the virtual character. In some embodiments, the motion information is a 40-dimensional vector. In some embodiments, a physics engine of the terminal simulates a pose of the virtual character in a next frame based on the internal torque reflected by the motion information and in combination with an external force and an external torque exerted on the virtual character by the virtual environment. In some embodiments, the motion controller is a three-layer multi-layer perceptron (MLP) neural network. This is not limited in this embodiment of this application. In some embodiments, the motion controller is also referred to as a policy network, and is configured to determine the subsequent motions of the virtual character.

In some embodiments, the terminal concatenates a feature vector of the first pose and a feature vector of the target information through the motion controller, to obtain a character feature vector. Then, the terminal determines the motion information of the virtual character based on the motion controller and the character feature vector. A dimension of the character feature vector is equal to a dimension of the feature vector of the first pose plus a dimension of the feature vector of the target information. Accordingly, the dimension of the character feature vector is 49+4=53 dimensions. In the solution provided in this embodiment of this application, the feature vector of the first pose and the feature vector of the target information are concatenated, so that the concatenated character feature vector can more accurately reflect the current state of the virtual character and the impact of the object on the current state of the virtual character, to more accurately calculate the motion information of the virtual character, to align with the intent of the object. This facilitates a more accurate simulation of the pose of the virtual character in a next picture frame subsequently, enabling a more accurate and realistic effect of the stand-up animation.

The process of the terminal determining the motion information of the virtual character based on the motion controller and the character feature vector includes: the terminal processing the character feature vector through the motion controller, to obtain initial motion information. Then, the terminal performs Gaussian distribution sampling with the initial motion information as a mean and a preset value as a standard deviation, to obtain the motion information. The preset value is any value.

In some embodiments, the process of processing the character feature vector through the motion controller includes: performing feature transformation on the character feature vector through a network layer in the motion controller, to obtain the initial motion information. In this embodiment of this application, after the feature vector of the first pose and the feature vector of the target information are inputted into the motion controller, the network layer in the motion controller concatenates the feature vector of the first pose and the feature vector of the target information into the character feature vector, and inputs the character feature vector into a subsequent network layer of the motion controller. The subsequent network layer of the motion controller performs feature transformation on the character feature vector, to output the initial motion information.

In some embodiments, the Gaussian distribution sampling process includes: constructing Gaussian distribution with the initial motion information as the mean and the preset value as the standard deviation; and sampling the Gaussian distribution by using a preset algorithm, to obtain the initial motion information. The preset algorithm is any sampling algorithm, such as an inverse transform method, a rejection sampling method, or an importance sampling method.

The preset value is not limited in this embodiment of this application. According to the solution provided in this embodiment of this application, after the initial motion information is calculated through the motion controller, Gaussian distribution sampling is performed on the initial motion information, so that finally determined motion information has randomness, making the pose of the virtual character in the next picture frame more varied and diverse. In addition, sampling is performed with the initial motion information as the mean, so that the sampled initial information does not deviate significantly from the initial motion information generated by the motion controller. In other words, on the basis of improving pose diversity, it ensures that the pose of the virtual character in the next picture frame does not deviate significantly from the pose controlled by the motion controller, thereby guaranteeing reasonableness of the pose transition of the virtual character.

In some embodiments, the terminal may calculate the initial motion information of the virtual character through the following formula 1.

$$m ( {s}_{t} , {g}_{t} ) = {W}_{2} * tanh ( {W}_{1} * tanh ( {W}_{0} * [ {s}_{t} , {g}_{t} ] + {b}_{0} ) + {b}_{1} ) + {b}_{2} . \qquad Formula 1$$

sₜ is configured for representing the feature vector of the first pose; gₜ is configured for representing the feature vector of the target information; [sₜ, gₜ] is configured for representing the character feature vector; m is configured for representing the initial motion information, and is a 40-dimensional vector; matrices W₀, W₁, and W₂ and bias vectors b₀, b₁, and b₂ are configured for representing network parameters of the motion controller, and tanh is configured for representing a hyperbolic tangent function.

In some embodiments, the server may calculate the motion information of the virtual character through the following formula 2.

$${a}_{t} ∼ N ( m , 0.15 ) . \qquad Formula 2$$

aₜ is configured for representing the motion information of the virtual character; m is configured for representing the initial motion information; 0.15 is configured for representing the preset value, that is, the standard deviation; and N is configured for representing the Gaussian distribution sampling.

304: The terminal simulates the stand-up motion of the virtual character based on the motion information and the first pose, to obtain a second pose of the virtual character, the second pose being configured for representing a pose of the virtual character in a second picture, and the second picture being a next picture frame of the first picture.

In this embodiment of this application, the terminal performs dynamics simulation on the stand-up motion of the virtual character based on the motion information and the first pose. In this application, the dynamics simulation is also referred to as physics simulation. In other words, the terminal calculates the motion information and the first pose of the virtual character based on dynamics knowledge, to obtain a motion trajectory of the subsequent motions of the virtual character. Then, the terminal determines the second pose of the virtual character based on the first pose and the motion trajectory of the subsequent motions.

In some embodiments, the terminal may further determine, based on an environment impact applied to the virtual character by a virtual environment, an external torque applied to the virtual character. Then, the terminal adjusts the first pose in combination with the external torque applied to the virtual character by the virtual environment and the internal torque (the motion information) applied to the virtual character by the object, to obtain the second pose of the virtual character. The solution provided in this embodiment of this application takes into account not only the impact of the object on the virtual character, but also the impact of factors in the virtual environment on the virtual character, making the pose transition of the virtual character more accurate and realistic, that is, enabling a more accurate and realistic effect of the stand-up animation.

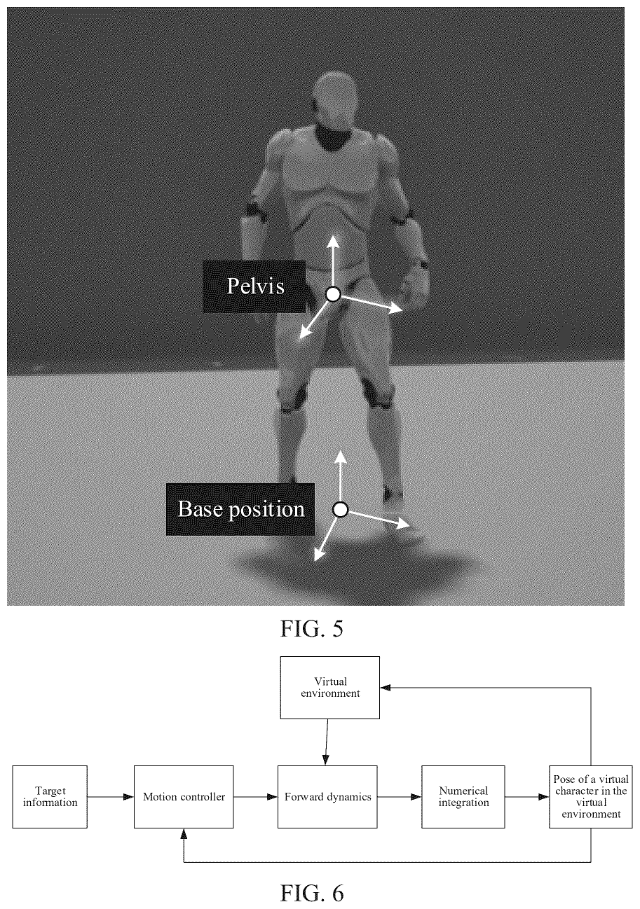

For example, FIG. 6 is a schematic diagram of generating a stand-up animation according to an embodiment of this application. Referring to FIG. 6, the terminal obtains the target information of the virtual character in the first picture in response to the operation performed by the object on the virtual character. The target information includes the operation performed by the object on the virtual character and the motion state of the virtual character. The terminal obtains the first pose of the virtual character in the first picture. Then, the terminal inputs the target information and the first pose of the virtual object into the motion controller, and processes the target information and the first pose through the motion controller, to obtain the motion information of the virtual character. Then, the terminal performs dynamics simulation on the stand-up motion of the virtual character based on the motion information and the first pose in combination with to the external torque applied to the virtual character by the virtual environment. The dynamics simulation includes forward dynamics and numerical integration. Then, the terminal obtains the second pose of the virtual character.

305: The terminal displays the second pose of the virtual character in the second picture, to present a stand-up animation of the virtual character.

In this embodiment of this application, after determining the second pose of the virtual character, the terminal renders and displays the second picture. The second picture displays the virtual character in the second pose. In other words, as the first picture switches to the second picture, the virtual character transitions from the first pose to the second pose. Accordingly, the pose transition process of the virtual character constitutes the stand-up animation of the virtual character.

According to the solution of this embodiment of this application, a pose of a virtual character in a current picture, an operation on the virtual character, and a motion state of the virtual character are inputted into a motion controller for processing, so that the motion controller applies an impact of an operation of an object based on the current pose and the motion state of the virtual character, to more accurately calculate motion information of the virtual character, to align with the intent of the object. Then, a stand-up motion of the virtual character is simulated based on the motion information and the first pose of the virtual character, enabling pose transitions of the virtual character to conform to the laws of motion, that is, making the pose transitions of the virtual character more realistic. In addition, the pose of the virtual character can be transitioned based on the guidance of the motion information, and a pose of the virtual character in a next picture frame is generated in real time, thereby improving accuracy and realism of the pose transition, that is, enabling a more accurate and realistic effect of the stand-up animation.

FIG. 7 is a flowchart of a motion controller training method according to an embodiment of this application. Referring to FIG. 7, this embodiment of this application is described by using an example in which the motion controller is performed by a server. The motion controller training method includes the following operations.

701: A server obtains a plurality of training samples of a virtual character based on a motion controller, each training sample including sample target information, a sample pose, and sample motion information of the virtual character in a corresponding picture, the sample target information including an operation performed by an object on the virtual character and a motion state of the virtual character, and the sample motion information being determined by the motion controller based on the sample target information and the sample pose.

In some embodiments, the server obtains the plurality of training samples from a terminal, where the plurality of training samples are generated by the motion controller of the terminal. A principle of the process of generating the plurality of training samples may be the same as the principle of performing operation 301 to operation 305. Details are not described herein again. A number of the plurality of training samples is not limited in this embodiment of this application. The server trains the motion controller through the plurality of training samples.

702: For any training sample, the server obtains a target training sample of the training sample, a picture corresponding to the target training sample being a next picture frame corresponding to the training sample, and a sample pose in the target training sample being obtained by performing simulation based on the sample pose and the sample motion information in the training sample.

In this embodiment of this application, for any training sample, the server obtains, from the plurality of training samples, the training sample corresponding to the next picture frame of the picture corresponding to the training sample, and uses the training sample as the target training sample of the training sample. The sample pose in the target training sample is obtained by performing simulation through the motion controller based on the sample pose and the sample motion information in the training sample.

This embodiment of this disclosure is described by using an example in which the target training sample of any one of the plurality of training samples is determined. In another embodiment, operation 701 and operation 702 do not need to be performed, and the training sample of the virtual character and the target training sample of the training sample are obtained based on the motion controller in another manner.

703: The server inputs the training sample and the target training sample into a discriminator network, to obtain a first loss, the first loss being configured for representing an error in recognition, by the discriminator network, of a pose transition generated by the motion controller, and the pose transition being a transition of the virtual character from a pose of the training sample to a pose of the target training sample.

In this embodiment of this application, for any training sample, the server inputs the training sample and the target training sample of the training sample into the discriminator network. Then, the server discriminates, through the discriminator network, whether the pose transition between the two inputted training samples is generated by the motion controller. The server may calculate the first loss based on the plurality of training samples and respective target training samples of the plurality of training samples.

In this embodiment of this application, the process of obtaining the first loss is equivalent to obtaining the first loss based on the training sample, the target training sample, and the discriminator network, the first loss is configured for representing an error of a first discrimination result, the first discrimination result is obtained by the discriminator network for the pose transition, and the first discrimination result is configured for representing a possibility that the pose transition is generated by the motion controller. In some embodiments, the process of obtaining the first loss includes: inputting the training sample and the target training sample into the discriminator network, the discriminator network outputs the first discrimination result, and the first loss is determined based on the first discrimination result.

704: The server trains the motion controller based on the first loss.

In this embodiment of this application, the server adjusts parameters of the motion controller with the goal of minimizing the first loss. In some embodiments, the server sends trained parameters of the motion controller to the terminal, and the terminal updates local parameters of the motion controller. In some embodiments, the server directly sends the trained motion controller to the terminal, so that the terminal updates the motion controller.

According to the solution provided in this embodiment of this application, for the training sample corresponding to any picture, the motion controller applies an impact of an operation of an object based on the sample pose and the sample motion information of the virtual character in the picture, to more accurately calculate the sample motion information of the virtual character, thereby obtaining a higher-quality training sample. Then, for training samples corresponding to two adjacent pictures, the discriminator network is used to discriminate whether a pose transition of the virtual character between the two adjacent pictures is generated by the motion controller, so that an obtained first loss can accurately reflect realism of the pose transition generated by the motion controller. In addition, the motion controller is trained through the first loss, enabling the pose transition generated by the motion controller to be increasingly accurate and realistic, thereby improving performance of the motion controller.

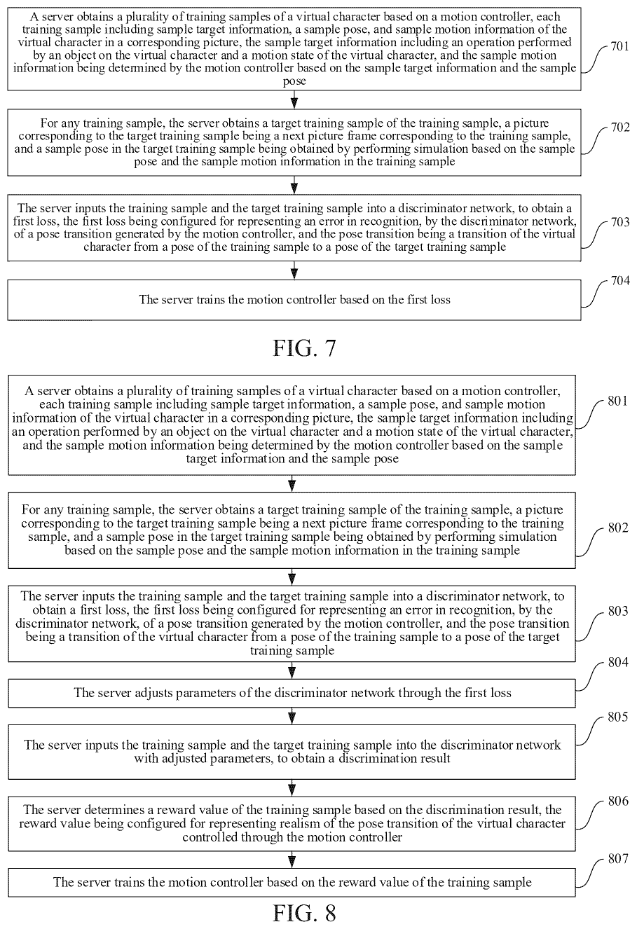

FIG. 8 is a flowchart of another motion controller training method according to an embodiment of this application. Referring to FIG. 8, this embodiment of this application is described by using an example in which the motion controller is performed by a server. The motion controller training method includes the following operations.

801: A server obtains a plurality of training samples of a virtual character based on a motion controller, each training sample including sample target information, a sample pose, and sample motion information of the virtual character in a corresponding picture, the sample target information including an operation performed by an object on the virtual character and a motion state of the virtual character, and the sample motion information being determined by the motion controller based on the sample target information and the sample pose.

In some embodiments, the server obtains the plurality of training samples from a terminal, where the plurality of training samples are generated by the motion controller. A principle of the process of generating the plurality of training samples may be the same as the principle of performing operation 301 to operation 305. Details are not described herein again. A number of the plurality of training samples is not limited in this embodiment of this application. In some embodiments, a number of training samples used in each round of training is 4096. The plurality of training samples originate from a plurality of game sessions or from different virtual scenes of the same game session. This is not limited in this embodiment of this application.

In some embodiments, the plurality of training samples originate from a plurality of game sessions. Accordingly, the process of the terminal obtaining the plurality of training samples of the virtual character based on the motion controller includes: for any game session, the terminal randomly extracting one picture frame from four reference animations. The four reference animations include a walking animation, a running animation, a supine-to-stand animation, and a prone-to-stand animation. Pictures in the four reference animations are configured for representing pose transitions of the virtual character in corresponding states in a real situation. The terminal performs a plurality of rounds of processing and a plurality of simulations through the motion controller with the pose of the virtual character in the picture as an initial pose of a current game session, to obtain sample target information, sample poses, and sample motion information of the virtual character in a plurality of pictures of the current game session. Then, the terminal uses the sample target information, the sample pose, and the sample motion information of the virtual character in each picture of the current game session as a training sample corresponding to the current game session, that is, the sample target information, the sample pose, and the sample motion information of the virtual character in any picture of the current game session is used as one training sample corresponding to the current game session, to obtain a total of a plurality of training samples corresponding to the current game session. Then, the server may directly obtain the plurality of training samples from the terminal. In the solution provided in this embodiment of this application, one picture frame is randomly extracted from the four reference animations, and a pose of the virtual character in this picture is used as the initial pose of the current game session, thereby enriching the initial pose of each game session. Based on this, the plurality of training samples are obtained from a plurality of game sessions. A movement trajectory of the virtual character in each game session generally varies. Accordingly, a pose transition of the virtual character that is generated from an initial pose in each game session also varies, thereby enriching poses of the virtual character used during training. This is beneficial to improving performance of the motion controller, enabling the trained motion controller to generate a diverse range of motions.

In some embodiments, the process of performing a plurality of rounds of processing and a plurality of simulations through the motion controller includes: obtaining sample target information of the virtual character in the first picture based on the foregoing operation 301 to operation 305 by using an example in which an extracted picture is the first picture; processing the sample target information and an initial pose of the virtual character in the first picture through the motion controller, to obtain the first sample motion information of the virtual character; simulating a motion of the virtual character based on the first sample motion information and the initial pose, to obtain a sample pose of the virtual character in the second picture; obtaining sample target information of the virtual character in the second picture; processing the sample target information of the virtual character in the second picture and the sample pose of the virtual character in the second picture through the motion controller, to obtain the second sample motion information of the virtual character; simulating the motion of the virtual character based on the second sample motion information and the sample pose of the virtual character in the second picture, to obtain a sample pose of the virtual character in the third picture; and repeating the foregoing process, to obtain the sample target information, the sample poses, and the sample motion information of the virtual character in the plurality of pictures.

The process of performing a plurality of rounds of processing and a plurality of simulations through the motion controller is similar to the foregoing operation 301 to operation 305. Details are not described herein again.

For example, before any game session starts, the terminal first randomly extracts one reference animation from four pre-obtained reference animations. Each reference animation has a 25% probability of being extracted. Then, the terminal randomly extracts a picture frame from the reference animation, and uses a pose of the virtual character in this picture frame as an initial pose s_0 of the virtual character in this game session. Then, during gameplay, the terminal performs processing and simulation through the motion controller from the initial pose s_0, to obtain a pose transition of the virtual character in this game session. If the walking animation or the running animation is extracted, the terminal determines that a value (phase) corresponding to the motion state of the virtual character is 0. If the supine-to-stand animation and the prone-to-stand animation are extracted, the terminal determines that the value corresponding to the motion state of the virtual character is determined by a remaining animation duration. For example, if the supine-to-stand animation lasts for three seconds, and the terminal extracts a pose at the 1.2-second moment as the initial post, in this case, a remaining duration of the supine-to-stand animation lasts for 1.8 seconds, and a value corresponding to the motion state of the virtual character is 1.8/3=0.6. The supine-to-stand animation refers to that when the stand-up animation starts, the virtual character lies face-up on the ground, and then bends forward and pushes backward with both hands against the ground to stand up. The prone-to-stand animation refers to that when the stand-up animation starts, the virtual character lies face-down on the ground, and then pushes forward with both hands against the ground to stand up.

In some embodiments, when the virtual character does not satisfy a balance condition, the terminal stops the current game session, to obtain a target picture of the current game session. The target picture is the last picture frame of the current game session. Then, one picture frame is randomly extracted from the four reference animations and the target picture, a plurality of rounds of processing and a plurality of simulations are performed again through the motion controller with the pose of the virtual character in the extracted picture as an initial pose of a next game session, to obtain sample target information, sample poses, and sample motion information of the virtual character in a plurality of pictures of the next game session. In addition, the terminal uses the sample target information, the sample poses, and the sample motion information of the virtual character in the plurality of pictures of the next game session as a plurality of training samples corresponding to the next game session. Due to the poor performance of the motion controller at the early stage of training, if the stand-up animation of the virtual character is simulated when the virtual character does not satisfy the balance condition, the virtual character merely flails and writhes on the ground after falling, making it impossible to collect training samples useful for normal walking/running training. In the solution provided in this embodiment of this application, when the virtual character does not satisfy the balance condition, the current game session is terminated, that is, training samples are stopped from being continuously obtained from the current game session, and then the next game session is restarted, to collect higher-quality training samples, which are beneficial to improving the performance of the motion controller subsequently.

For example, after each game session is terminated, if a number of collected training samples has not yet reached a requirement (for example, 4096 frames), the terminal may start the next game session, and continue to collect training samples. In this case, the terminal stores the pose of the virtual character in the last picture frame of a previous game session. Then, the terminal performs random sampling, so that the terminal has a 20% probability of using the stored pose to initialize the character pose for a next game session, and a value corresponding to the motion state of the virtual character is set to 1. Then, the terminal performs processing and simulation through the motion controller, to obtain the pose transition of the virtual character in the next game session. The next game session will last for at least three seconds. The terminal has an 80% probability of performing pose initialization on the next game session in the original manner, that is, by randomly extracting from the four reference animations. Due to the implementation of this trajectory termination and pose initialization mechanism, various poses the virtual character may present after transitioning from walking/running to falling can be considered in deep reinforcement learning algorithm training, rather than being limited to the falling poses as in the reference animation. Through simulation, an animation generation effect where smooth transitions from any pose to the final stand-up can be achieved is explored.

In some embodiments, if the supine-to-stand animation or the prone-to-stand animation is extracted during pose initialization, the terminal does not perform determining of the balance condition within the remaining duration (for example, the foregoing 1.8 seconds) of the animation, or terminate the game session. After this time has elapsed, the terminal performs determining of the balance condition on the virtual character in each subsequent picture frame. If the virtual character is determined to be unbalanced, the terminal may also terminate this game session and enter the next game session.

802: For any training sample, the server obtains a target training sample of the training sample, a picture corresponding to the target training sample being a next picture frame corresponding to the training sample, and a sample pose in the target training sample being obtained by performing simulation based on the sample pose and the sample motion information in the training sample.

In this embodiment of this application, for any training sample, the server obtains, from the plurality of training samples, the training sample corresponding to the next picture frame of the picture corresponding to the training sample, and uses the training sample as the target training sample of the training sample. The sample pose in the target training sample is obtained by performing simulation through the motion controller based on the sample pose and the sample motion information in the training sample.

803: The server inputs the training sample and the target training sample into a discriminator network, to obtain a first loss, the first loss being configured for representing an error in recognition, by the discriminator network, of a pose transition generated by the motion controller, and the pose transition being a transition of the virtual character from a pose of the training sample to a pose of the target training sample.

In this embodiment of this application, for any training sample, the server may input the training sample and the target training sample of the training sample into the discriminator network simultaneously. Then, the server discriminates, through the discriminator network, whether a pose transition between the inputted training sample and the inputted target training sample of the training sample is generated by the motion controller, to obtain a first discrimination result. Then, the server calculates the first loss based on the first discrimination results of the plurality of training samples.

In some embodiments, the server may calculate the discrimination result of the training sample through the following formula 3.

$$D ( {s}_{t} , {s}_{t + 1} ) = {W}_{8} * tanh ( {W}_{7} * tanh ( {W}_{6} * [ {s}_{t} , {s}_{t + 1} ] + {b}_{6} ) + {b}_{7} ) + {b}_{8} . \qquad Formula 3$$

sₜ is configured for representing a feature vector of the sample pose in the training sample; sₜ₊₁ is configured for representing a feature vector of the sample pose in the target training sample; [sₜ, sₜ₊₁] is configured for representing a feature vector of a concatenated sample pose with a dimension of 49×2=98; matrices W₆, W₇, and W₈ and bias vectors b₆, b₇, and b₈ are configured for representing network parameters of the discriminator network; D is configured for representing the first discrimination result of the training sample, and is a vector with a dimension of one; and tanh is configured for representing a hyperbolic tangent function.

In some embodiments, in addition to training based on the plurality of training samples generated by the motion controller, the server further obtains a plurality of reference samples from the foregoing four reference animations, to train the motion controller. The plurality of reference samples are configured for reflecting a pose transition of the virtual character in a real situation. Accordingly, the server may calculate the first loss through the following formula 4.

$${L}_{D} = {{\sum }_{( {s}_{t} , {s}_{t + 1} ) ∈ π} [ D ( {s}_{t} , {s}_{t + 1} ) + 1 ]}^{2} + {{\sum }_{( {s}_{t} , {s}_{t + 1} ) ∈ E} [ D ( {s}_{t} , {s}_{t + 1} ) - 1 ]}^{2} . \qquad Formula 4$$

π is configured for representing the motion controller; (sₜ, sₜ₊₁)∈π is configured for representing that the pose transition of the virtual character is simulated by the terminal through the motion controller; E is configured for representing the four reference animations; (sₜ, sₜ₊₁)∈E is configured for representing that the pose transition of the virtual character is directly extracted by the server from the four fixed reference animations; D(sₜ, sₜ₊₁) is configured for representing the first discrimination result of the training sample; and L_{D} is configured for representing the first loss, that is, a loss of a discriminator network D. A function of the discriminator network D is to discriminate whether such a pose transition (sₜ, sₜ₊₁) is simulated based on the motion controller of the terminal or originates from a dataset of the pose transition in a real situation. If (sₜ, sₜ₊₁) is simulated based on the motion controller of the terminal, during training, the discriminator network is expected to output −1. If the pose transition originates from the dataset of the pose transition in a real situation, during training, the discriminator network is expected to output 1.

804: The server adjusts parameters of the discriminator network through the first loss.

In this embodiment of this application, the server adjusts the parameters of the discriminator network with the goal of minimizing the first loss, so that the discriminator network can more accurately discriminate whether the sample pose in the training sample is simulated by the motion controller. When the motion controller is finally well trained subsequently, the motion controller can control the virtual character in the terminal to make a motion very similar to the motion in the reference animation. In this case, the pose transition (sₜ, sₜ₊₁) generated by the motion controller can deceive the discriminator network, causing the output of the discriminator network to slowly transition from −1 to 1.

805: The server inputs the training sample and the target training sample into the discriminator network with adjusted parameters, to obtain a second discrimination result.

In this embodiment of this application, the server discriminates the training sample and the target training sample again through the discriminator network with adjusted parameters, to obtain the second discrimination result of the training sample. A principle of calculating the second discrimination result by the server is the same as the principle of calculating the first discrimination result in operation 703. Details are not described herein again.

806: The server determines a reward value of the training sample based on the second discrimination result, the reward value being configured for representing realism of the pose transition of the virtual character controlled through the motion controller.

In this embodiment of this application, the server sets the reward value for the discrimination result of the training sample, to encourage the pose transition controlled by the motion controller to be increasingly realistic. Specifically, when the pose transition simulated by the terminal through the motion controller is more similar to an actual pose transition in the reference animation, the reward value determined by the server is higher, and when the pose transition simulated by the terminal through the motion controller is farther from the actual pose transition in the reference animation, the reward value determined by the server is lower. In other words, the reward value is in positive correlation with realism of the pose transition simulated by the motion controller.

In some embodiments, the server calculates the reward value of the training sample through the following formula 5.

$${r}_{t} = max ( 0 , 1 - 0.25 * {( {D}_{1} ( {s}_{t} , {s}_{t + 1} ) - 1 )}^{2} ) . \qquad Formula 5$$

rₜ is configured for representing the reward value of the training sample; D₁(sₜ, sₜ₊₁) is configured for representing the second discrimination result of the training sample; D₁ is the discriminator network with adjusted parameters; sₜ is configured for representing a feature vector of the sample pose in the training sample; and sₜ₊₁ is configured for representing a feature vector of the sample pose in the target training sample.

807: The server trains the motion controller based on the reward value of the training sample.

In this embodiment of this application, the server can input the training sample and the target training sample separately into a value network, to obtain value of the training sample and value of the target training sample. The value is configured for representing quality of the corresponding training sample. Then, the process of the server training the motion controller based on the reward value of the training sample includes: the server training the motion controller based on the reward value of the training sample, the value of the training sample, and the value of the target training sample.

In some embodiments, the server may calculate the value of the training sample through the following formula 6.

$$V ( {s}_{t} ) = {W}_{5} * tanh ( {W}_{4} * tanh ( {W}_{3} * {s}_{t} + {b}_{3} ) + {b}_{4} ) + {b}_{5} . \qquad Formula 6$$

sₜ is configured for representing the feature vector of the sample pose in the training sample; V(sₜ) is configured for representing the value of the training sample, and is a scalar with a dimension of one; matrices W₃, W₄, and W₅ and bias vectors b₃, b₄, and b₅ are configured for representing the network parameter of the discriminator network; and tanh is configured for representing a hyperbolic tangent function.

In some embodiments, the process of the server training the motion controller based on the reward value of the training sample, the value of the training sample, and the value of the target training sample includes: the server determining an advantage value of the training sample based on the reward value of the training sample, the value of the training sample, and the value of the target training sample. The advantage value is configured for representing contribution of the training sample to the training of the motion controller. Then, the server determines a second loss based on the plurality of training samples and advantage values of the plurality of training samples. The second loss is configured for representing an error in determining, by the motion controller, subsequent motions of the virtual character. The server trains the motion controller based on the second loss.

In some embodiments, the server may calculate the advantage value of the training sample through the following formula 7.

$${A}_{t} = {r}_{t} + 0.95 * V ( {s}_{t + 1} ) - V ( {s}_{t} ) . \qquad Formula 7$$

Aₜ is configured for representing the advantage value of the training sample; rₜ is configured for representing the reward value of the training sample; sₜ is configured for representing the feature vector of the sample pose in the training sample; V(sₜ) is configured for representing the value of the training sample; sₜ₊₁ is configured for representing the feature vector of the sample pose in the target training sample; and V(sₜ₊₁) is configured for representing the value of the target training sample.

In some embodiments, the server may calculate the second loss through the following formula 8.

$${L}_{π} = \sum {{A}_{t} [ {a}_{t} - m ( {s}_{t} , {g}_{t} ) ]}^{2} . \qquad Formula 8$$

π is configured for representing the motion controller; L_{π} is configured for representing the second loss, that is, the loss of the motion controller; Aₜ is configured for representing the advantage value of the training sample; aₜ is configured for representing sample motion information of the training sample; m is configured for representing initial motion information of the training sample; sₜ is configured for representing the sample pose of the training sample; and g is configured for representing the sample target information of the training sample.

In some embodiments, the server can further determine a third loss based on the advantage values of the plurality of training samples. Then, the server trains the value network through the third loss. The server may calculate the third loss through the following formula 9.

$${L}_{V} = \sum {[ {r}_{t} + 0.95 * V ( {s}_{t + 1} ) - V ( {s}_{t} ) ]}^{2} . \qquad Formula 9$$

V is configured for representing the value network; L_{V} is configured for representing the third loss, that is, a loss of the value network; rₜ is configured for representing the reward value of the training sample; sₜ is configured for representing the feature vector of the sample pose in the training sample; V(sₜ) is configured for representing the value of the training sample; sₜ₊₁ is configured for representing the feature vector of the sample pose in the target training sample; and V(sₜ₊₁) is configured for representing the value of the target training sample.

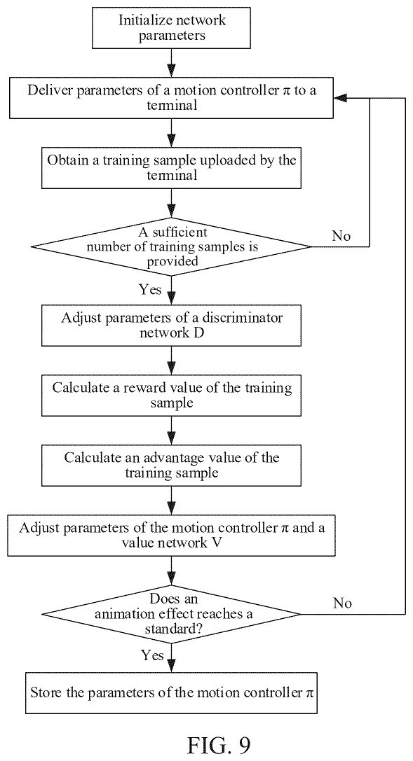

To describe the motion controller training method provided in this embodiment of this application more clearly, the following description is provided with reference to the accompanying drawings. FIG. 9 shows a motion controller training method according to an embodiment of this application. Referring to FIG. 9, a server initializes parameters of a motion controller π, a value network V, and a discriminator network D. Then, the server delivers the parameters of the motion controller π to a terminal. The terminal simulates a pose of a virtual character based on the parameters of the motion controller π, to obtain a training sample. The server obtains the training sample from the terminal. If a sufficient number of training samples is provided, the server adjusts the parameters of the discriminator network D based on a plurality of training samples. Next, the server calculates a reward value and an advantage value of the training sample. Then, the server calculates a loss of the motion controller π and a loss of the value network V based on the reward value and the advantage value of the training sample, to adjust the parameters of the motion controller π and the value network V. Finally, the server transmits the parameters of the motion controller π to the terminal, to determine whether an effect of a stand-up animation generated by the motion controller π reaches a standard. When the effect of the stand-up animation reaches the standard, the terminal stores the parameters of the motion controller π. Otherwise, the terminal continues to provide training samples to the server.

According to the solution provided in this embodiment of this application, for the training sample corresponding to any picture, the motion controller applies an impact of an operation of an object based on the sample pose and the sample motion information of the virtual character in the picture, to more accurately calculate the sample motion information of the virtual character, thereby obtaining a higher-quality training sample. Then, for training samples corresponding to two adjacent pictures, the discriminator network is used to discriminate whether a pose transition of the virtual character between the two adjacent pictures is generated by the motion controller, so that an obtained first loss can accurately reflect realism of the pose transition generated by the motion controller. In addition, the motion controller is trained through the first loss, enabling the pose transition generated by the motion controller to be increasingly accurate and realistic, thereby improving performance of the motion controller.

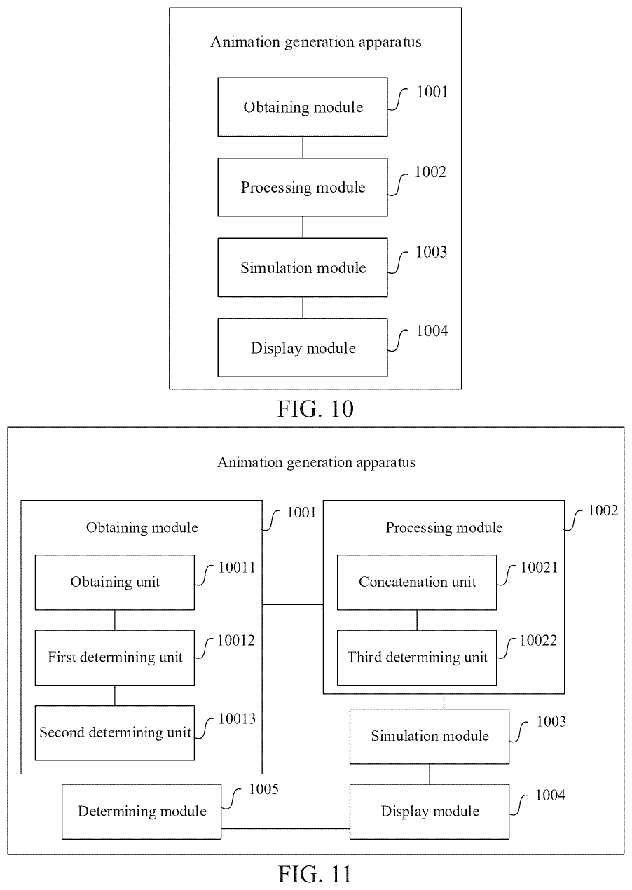

FIG. 10 is a block diagram of an animation generation apparatus according to an embodiment of this application. The animation generation apparatus is configured to perform operations of the foregoing animation generation method. Referring to FIG. 10, the apparatus includes an obtaining module 1001, a processing module 1002, a simulation module 1003, and a display module 1004.

The obtaining module 1001 is configured to obtain target information and a first pose of a virtual character in a first picture, the target information including an operation performed by an object on the virtual character and a motion state of the virtual character, the motion state being a stand-up state or a walking/running state, and the first pose being configured for representing a pose of the virtual character in the first picture.

The processing module 1002 is configured to process the target information and the first pose through a motion controller when the virtual character is in the stand-up state, to obtain motion information of the virtual character, the motion controller being configured to determine subsequent motions of the virtual character, and the motion information is configured for representing an internal torque applied to the virtual character by the operation of the object.

The simulation module 1003 is configured to simulate the stand-up motion of the virtual character based on the motion information and the first pose, to obtain a second pose of the virtual character, the second pose being configured for representing a pose of the virtual character in a second picture, and the second picture being a next picture frame of the first picture.

The display module 1004 is configured to display the second pose of the virtual character in the second picture, to present a stand-up animation of the virtual character.

In some embodiments, FIG. 11 is a block diagram of another animation generation apparatus according to an embodiment of this application. Referring to FIG. 11, the obtaining module 1001 includes an obtaining unit 10011, a first determining unit 10012, and a second determining unit 10013.

The obtaining unit 10011 is configured to: obtain, in response to the operation on the virtual character, an expected movement direction and an expected movement speed of the virtual character, the expected movement direction and the expected movement speed being configured for reflecting an expected subsequent movement status of the virtual character.

The first determining unit 10012 is configured to determine a motion state of the virtual character in the first picture based on an expected duration of the stand-up animation and the first picture.

The second determining unit 10013 is configured to determine the target information of the virtual character in the first picture.

In some embodiments, the stand-up state includes a stand-up progress, where the stand-up progress is a progress of the stand-up animation displayed in a process of the virtual character from lying down to standing up. Still referring to FIG. 11, the first determining unit 10012 is configured to: determine a number of frames corresponding to the stand-up animation based on the expected duration of the stand-up animation; determine a unit progress value based on the number of frames and an initial value of the stand-up progress of the virtual character, the initial value being configured for representing the stand-up state of the virtual character in the first picture frame of the stand-up animation, and the unit progress value being configured for representing a difference in the stand-up progress of the virtual character between two adjacent picture frames, the two adjacent picture frames being any two adjacent picture frames in the stand-up animation; and determine the motion state of the virtual character in the first picture based on the initial value, the unit progress value, and a time sequence of the first picture in the stand-up animation.

In some embodiments, still referring to FIG. 11, the obtaining module 1001 is configured to: obtain angle values of a plurality of rotatable joints on the virtual character, the angle values of the plurality of rotatable joints being configured for reflecting poses of the plurality of rotatable joints; and determine the first pose of the virtual character based on the angle values of the plurality of rotatable joints, a position vector of a pelvis of the virtual character, and a pose vector of the pelvis.

In some embodiments, still referring to FIG. 11, the processing module 1002 includes a concatenation unit 10021 and a third determining unit 10022.

The concatenation unit 10021 is configured to concatenate a feature vector of the first pose and a feature vector of the target information through the motion controller, to obtain a character feature vector.

The third determining unit 10022 is configured to determine the motion information of the virtual character based on the motion controller and the character feature vector.

In some embodiments, still referring to FIG. 11, a third determining unit 10022 is configured to: process the character feature vector through the motion controller, to obtain initial motion information; and perform Gaussian distribution sampling with the initial motion information as a mean and a preset value as a standard deviation, to obtain the motion information.

In some embodiments, still referring to FIG. 11, the apparatus further includes a determining module 1005, configured to: determine, when the virtual character is in the walking/running state, based on a position of a pelvis of the virtual character and an angle of the pelvis, whether the virtual character satisfies a balance condition; update the motion state of the virtual character from the walking/running state to the stand-up state when the virtual character does not satisfy the balance condition; and maintain the motion state of the virtual character as the walking/running state when the virtual character satisfies the balance condition.

Embodiments of this application provide an animation generation apparatus. A pose of a virtual character in a current picture, an operation on the virtual character, and a motion state of the virtual character are inputted into a motion controller for processing, so that the motion controller applies an impact of an operation of an object based on the current pose and the motion state of the virtual character, to more accurately calculate motion information of the virtual character, to align with the intent of the object. Then, a stand-up motion of the virtual character is simulated based on the motion information and the first pose of the virtual character, enabling pose transitions of the virtual character to conform to the laws of motion, that is, making the pose transitions of the virtual character more realistic.

In addition, the pose of the virtual character can be transitioned based on the guidance of the motion information, and a pose of the virtual character in a next picture frame is generated in real time, thereby improving accuracy and realism of the pose transition, that is, enabling a more accurate and realistic effect of the stand-up animation.

When the animation generation apparatus provided in the foregoing embodiment runs an application, only divisions of the foregoing functional modules are described by using an example. In an actual application, the functions may be allocated to and completed by different functional modules according to requirements. In other words, an internal structure of the apparatus is divided into different functional modules, to complete all or some of the functions described above. In addition, the animation generation apparatus provided in the foregoing embodiment is based on the same concept as the animation generation method in the foregoing embodiments. For the specific implementation process, refer to the method embodiments. Details are not described herein again.

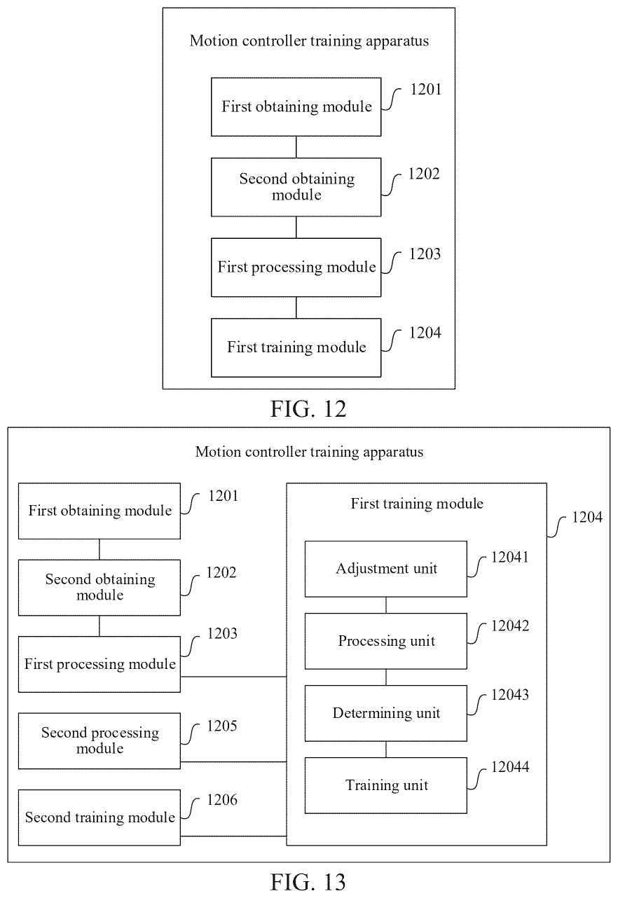

FIG. 12 is a block diagram of a motion controller training apparatus according to an embodiment of this application. The motion controller training apparatus is configured to perform operations in the foregoing motion controller training method. Referring to FIG. 12, the apparatus includes a first obtaining module 1201, a second obtaining module 1202, a first processing module 1203, and a first training module 1204.

The first obtaining module 1201 is configured to obtain a training sample of a virtual character based on a motion controller, the training sample including sample target information, a sample pose, and sample motion information of the virtual character in a corresponding picture, the sample target information including an operation on the virtual character and a motion state of the virtual character, and the sample motion information being determined by the motion controller based on the sample target information and the sample pose.

The second obtaining module 1202 is configured to obtain a target training sample of the training sample, a picture corresponding to the target training sample being a next picture frame corresponding to the training sample, and a sample pose in the target training sample being obtained by performing simulation based on the sample pose and the sample motion information in the training sample.

The first processing module 1203 is configured to obtain a first loss based on the training sample, the target training sample, and a discriminator network, the first loss being configured for representing an error of a first discrimination result, the first discrimination result being obtained by the discriminator network for a pose transition, the first discrimination result indicating a possibility that the pose transition is generated by the motion controller, and the pose transition being a transition of the virtual character from a pose of the training sample to a pose of the target training sample.

The first training module 1204 is configured to train the motion controller based on the first loss.

In some embodiments, the first obtaining module 1201 is configured to obtain a plurality of training samples of the virtual character based on the motion controller.

The second obtaining module 1202 is configured to determine, for any training sample, a target training sample of the training sample from the plurality of training samples.

In some embodiments, the plurality of training samples originate from a plurality of game sessions, and the process of obtaining a plurality of training samples of the virtual character based on the motion controller includes: randomly extracting one picture frame from four reference animations for any game session, the four reference animations including a walking animation, a running animation, a supine-to-stand animation, and a prone-to-stand animation; performing a plurality of rounds of processing and a plurality of simulations through the motion controller with the pose of the virtual character in the picture as an initial pose of a current game session, to obtain sample target information, sample poses, and sample motion information of the virtual character in a plurality of pictures of the current game session; and using the sample target information, the sample pose, and the sample motion information of the virtual character in each picture of the current game session as a training sample corresponding to the current game session.

In some embodiments, the process of obtaining a plurality of training samples of the virtual character based on the motion controller further includes: stopping the current game session when the virtual character does not satisfy a balance condition, to obtain a target picture of the current game session, the target picture being the last picture frame of the current game session; randomly extracting one picture frame from the four reference animations and the target picture, and performing a plurality of rounds of processing and a plurality of simulations again through the motion controller with the pose of the virtual character in the picture as an initial pose of a next game session, to obtain sample target information, sample poses, and sample motion information of the virtual character in a plurality of pictures of the next game session; and using the sample target information, the sample pose, and the sample motion information of the virtual character in each picture of the next game session as a training sample corresponding to the next game session.

In some embodiments, FIG. 13 is a block diagram of another motion controller training apparatus according to an embodiment of this application. Referring to FIG. 13, the first training module 1204 includes an adjustment unit 12041, a processing unit 12042, a determining unit 12043, and a training unit 12044.

The adjustment unit 12041 is configured to adjust parameters of the discriminator network through the first loss.

The processing unit 12042 is configured to input the training sample and the target training sample into the discriminator network with adjusted parameters, to obtain a second discrimination result.

The determining unit 12043 is configured to determine a reward value of the training sample based on the second discrimination result, the reward value being configured for representing realism of the pose transition of the virtual character controlled through the motion controller.

The training unit 12044 is configured to train the motion controller based on the reward value of the training sample.

In some embodiments, still referring to FIG. 13, the apparatus further includes a second processing module 1205, configured to input the training sample and the target training sample separately into a value network, to obtain value of the training sample and value of the target training sample, the value being configured for representing quality of the corresponding training sample.

The training unit 12044 is configured to train the motion controller based on the reward value of the training sample, the value of the training sample, and the value of the target training sample.

In some embodiments, still referring to FIG. 13, the training unit 12044 is configured to: determine an advantage value of the training sample based on the reward value of the training sample, the value of the training sample, and the value of the target training sample, the advantage value being configured for representing contribution of the training sample to the training of the motion controller; determine a second loss based on the plurality of training samples and advantage values of the plurality of training samples, the second loss being configured for representing an error in determining, by the motion controller, subsequent motions of the virtual character; and train the motion controller based on the second loss.

In some embodiments, still referring to FIG. 13, the apparatus further includes a second training module 1206, configured to: determine a third loss based on the advantage values of the plurality of training samples; and train the value network through the third loss.

According to the motion controller training apparatus provided in this embodiment of this application, for the training sample corresponding to any picture, the motion controller applies an impact of an operation of an object based on the sample pose and the sample motion information of the virtual character in the picture, to more accurately calculate the sample motion information of the virtual character, thereby obtaining a higher-quality training sample. Then, for training samples corresponding to two adjacent pictures, the discriminator network is used to discriminate whether a pose transition of the virtual character between the two adjacent pictures is generated by the motion controller, so that an obtained first loss can accurately reflect realism of the pose transition generated by the motion controller. In addition, the motion controller is trained through the first loss, enabling the pose transition generated by the motion controller to be increasingly accurate and realistic, thereby improving performance of the motion controller.

When the motion controller training apparatus provided in the foregoing embodiment runs an application, only divisions of the foregoing functional modules are described by using an example. In an actual application, the functions may be allocated to and completed by different functional modules according to requirements. In other words, an internal structure of the apparatus is divided into different functional modules, to complete all or some of the functions described above. In addition, the motion controller training apparatus provided in the foregoing embodiments and the embodiments of the motion controller training method are based on the same concept. For the specific implementation process, refer to the method embodiments. Details are not described herein again.

In the embodiments of this application, the computer device may be configured as a terminal or a server. When the computer device is configured as a terminal, the terminal may be used as an execution body to implement the technical solutions provided in the embodiments of this application. When the computer device is configured as a server, the server may be used as an execution body to implement the technical solutions provided in the embodiments of this application, or the technical solutions provided in this application may be implemented through interaction between a terminal and a server. This is not limited in this embodiment of this application.

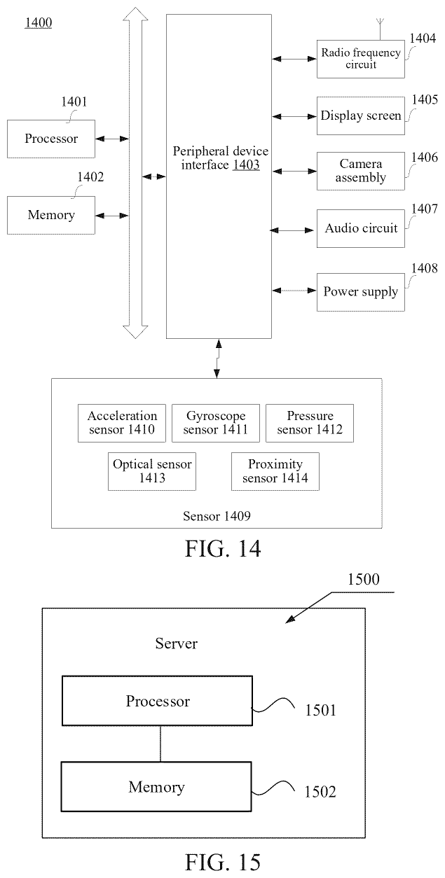

FIG. 14 is a structural block diagram of a terminal 1400 according to an embodiment of this application. The terminal 1400 may be a portable mobile terminal, for example, a smartphone, a tablet computer, a moving picture experts group audio layer III (MP3) player, a moving picture experts group audio layer IV (MP4) player, a notebook computer, or a desktop computer. The terminal 1400 may also be referred to as another name such as user equipment, a portable terminal, a laptop terminal, or a desktop terminal. Generally, the terminal 1400 includes a processor 1401 and a memory 1402.

The processor 1401 may include one or more processing cores, such as a 4-core processor and an 8-core processor. The processor 1401 may be implemented in at least one hardware form of a digital signal processor (DSP), a field-programmable gate array (FPGA), and a programmable logic array (PLA). The processor 1401 may also include a main processor and a co-processor. The main processor is a processor configured to process data in an awake state, and is also referred to as a central processing unit (CPU). The co-processor is a low power consumption processor configured to process the data in a standby state. In some embodiments, the processor 1401 may be integrated with a graphics processing unit (GPU). The GPU is configured to render and draw content that needs to be displayed on a display. In some embodiments, the processor 1401 may further include an artificial intelligence (AI) processor. The AI processor is configured to process a computing operation related to machine learning.

The memory 1402 may include one or more computer-readable storage media. The computer-readable storage medium may be non-transient. The memory 1402 may also include a high-speed random access memory, a nonvolatile memory, such as one or more disk storage devices and flash storage devices. In some embodiments, a non-transitory computer-readable storage medium in the memory 1402 is configured to store at least one computer program. The at least one computer program is configured to be executed by the processor 1401, to implement the animation generation method or the motion controller training method provided in the method embodiments of this application.

In some embodiments, the terminal 1400 further exemplarily includes a peripheral device interface 1403 and at least one peripheral device. The processor 1401, the memory 1402, and the peripheral device interface 1403 may be connected through a bus or a signal cable. Each peripheral device may be connected to the peripheral device interface 1403 through the bus, the signal cable, or a circuit board. Specifically, the peripheral device includes at least one of a radio frequency circuit 1404, a display screen 1405, a camera assembly 1406, an audio circuit 1407, and a power supply 1408.

The peripheral device interface 1403 may be configured to connect at least one peripheral device related to I/O to the processor 1401 and the memory 1402. In some embodiments, the processor 1401, the memory 1402, and the peripheral device interface 1403 are integrated on a same chip or a circuit board. In some other embodiments, any one or two of the processor 1401, the memory 1402, and the peripheral device interface 1403 may be implemented on a single chip or the circuit board. This is not limited in this embodiment.

The radio frequency circuit 1404 is configured to receive and transmit a radio frequency (RF) signal, which is also referred to as an electromagnetic signal. The radio frequency circuit 1404 communicates with a communication network and another communication device through the electromagnetic signal. The radio frequency circuit 1404 converts an electrical signal into the electromagnetic signal for transmission, or converts a received electromagnetic signal into the electrical signal. In some embodiments, the radio frequency circuit 1404 includes an antenna system, an RF transceiver, one or more amplifiers, a tuner, an oscillator, a digital signal processor, an encoding and decoding chipset, a subscriber identity module card, and the like. The radio frequency circuit 1404 may communicate with another terminal through at least one wireless communication protocol. The wireless communication protocol includes, but is not limited to, the world wide web, a metropolitan area network, an intranet, various mobile communication networks (2G, 3G, 4G, and 5G), a wireless local area network, and/or a wireless fidelity (Wi-Fi) network. In some embodiments, the radio frequency circuit 1404 may further include a circuit related to near field communication (NFC). This is not limited in this application.

The display screen 1405 is configured to display a user interface (UI). The UI may include a graph, a text, an icon, a video, or any combination thereof. When the display screen 1405 is a touch display screen, the display screen 1405 further has a capability of collecting a touch signal on or above a surface of the display screen 1405. The touch signal may be inputted into the processor 1401 as a control signal for processing. In this case, the display screen 1405 may further be configured for providing a virtual button and/or a virtual keyboard, also referred to as a soft button and/or a soft keyboard. In some embodiments, there may be one display screen 1405, and the display screen 1405 is arranged on a front panel of the terminal 1400. In some other embodiments, there may be at least two display screens that are respectively arranged on different surfaces of the terminal 1400 or in a folded design. In some other embodiments, the display screen 1405 may be a flexible display screen, and is arranged on a curved surface or a folded surface of the terminal 1400. Even, the display screen 1405 may be set to be a non-rectangular irregular figure, that is, a special-shaped screen. The display screen 1405 may be prepared by using a material such as a liquid crystal display (LCD) or an organic light-emitting diode (OLED).

The camera assembly 1406 is configured for capturing an image or a video. In some embodiments, the camera assembly 1406 includes a front camera and a rear camera. Usually, the front camera is arranged on a front panel of the terminal, and the rear camera is arranged on a back surface of the terminal. In some embodiments, there are at least two rear cameras, which are respectively any one of a main camera, an in-depth-field camera, a wide-angle camera, and a telephoto camera, to fuse the main camera and the in-depth-field camera to implement a background blurring function, to fuse the main camera and the wide-angle camera to implement panorama photographing and a virtual reality (VR) photographing function, or another fusion photographing function. In some embodiments, the camera assembly 1406 may further include a flash. The flash may be a solid-color temperature flash, or may be a dual-color temperature flash. The dual-color temperature flash refers to a combination of a warm-light flash and a cool-light flash, and may be configured for light compensation in different color temperatures.

The audio circuit 1407 may include a microphone and a speaker. The microphone is configured for collecting sound waves of a user and an environment, convert the sound waves into the electric signal, and input the electric signal to the processor 1401 for processing, or input the electric signal to the radio frequency circuit 1404 for implementing voice communication. For the purpose of stereophonic sound collection or denoising, there may be a plurality of microphones, and the microphones are respectively arranged at different parts of the terminal 1400. The microphone may alternatively be an array microphone or an omnidirectional microphone. The speaker is configured for converting the electric signal from the processor 1401 or the radio frequency circuit 1404 into an acoustic wave. The speaker may be a conventional thin-film speaker, or may be a piezoelectric ceramic speaker.

When the speaker is the piezoelectric ceramic speaker, the speaker not only can convert the electric signal into a sound wave audible to human, but also can convert the electric signal into a sound wave inaudible to human, for the purpose such as ranging. In some embodiments, the audio circuit 1407 may further include a headphone jack.

The power supply 1408 is configured for supplying power to components in the terminal 1400. The power supply 1408 may be an alternating current, a direct current, a disposable battery, or a rechargeable battery. When the power supply 1408 includes the rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may further be configured for supporting a fast charge technology.

In some embodiments, the terminal 1400 further includes one or more sensors 1409. The one or more sensors 1409 include, but are not limited to, an acceleration sensor 1410, a gyroscope sensor 1411, a pressure sensor 1412, an optical sensor 1413, and a proximity sensor 1414.

The acceleration sensor 1410 may detect magnitude of accelerations on three coordinate axes of a coordinate system established by the terminal 1400. For example, the acceleration sensor 1410 may be configured for detecting components of a gravitational acceleration on the three coordinate axes. The processor 1401 may control, based on a gravity acceleration signal collected by the acceleration sensor 1410, the display screen 1405 to display the user interface in a landscape mode or a portrait mode. The acceleration sensor 1410 may further be configured for collecting movement data of a game or a user.

The gyroscope sensor 1411 may detect a body direction and a rotation angle of the terminal 1400. The gyroscope sensor 1411 may cooperate with the acceleration sensor 1410 to collect a 3D motion of the user on the terminal 1400. The processor 1401 may implement the following functions based on data collected by the gyroscope sensor 1411: motion sensing (for example, changing the UI based on a tilt operation of a user), image stability during photographing, game control, and inertial navigation.

The pressure sensor 1412 may be arranged on a side frame of the terminal 1400 and/or a lower layer of the display screen 1405. When being arranged on the side frame of the terminal 1400, the pressure sensor 1412 may detect a holding signal of the user on the terminal 1400, and the processor 1401 performs left-right recognition or a shortcut operation based on the holding signal collected by the pressure sensor 1412. When the pressure sensor 1412 is arranged at the lower layer of the display screen 1405, the processor 1401 controls an operable control on the UI interface based on a pressure operation of the user on the display screen 1405. The operable control includes at least one of a button control, a scroll bar control, an icon control, and a menu control.

The optical sensor 1413 is configured for collecting an ambient light intensity. In an embodiment, the processor 1401 may control display luminance of the display screen 1405 based on the ambient light intensity collected by the optical sensor 1413. Specifically, when the ambient light intensity is high, the display luminance of the display screen 1405 is increased. When the ambient light intensity is low, the display luminance of the display screen 1405 is decreased. In another embodiment, the processor 1401 may further dynamically adjust the photographing parameter of the camera assembly 1406 based on the ambient light intensity collected by the optical sensor 1413.

The proximity sensor 1414 is also referred to as a distance sensor, and is usually arranged on the front panel of the terminal 1400. The proximity sensor 1414 is configured for collecting a distance between the user and a front face of the terminal 1400. In an embodiment, when the proximity sensor 1414 detects that the distance between the user and the front face of the terminal 1400 gradually becomes smaller, the processor 1401 controls the display screen 1405 to switch from a screen-on state to a screen-off state. When the proximity sensor 1414 detects that the distance between the user and the front face of the terminal 1400 gradually increases, the processor 1401 controls the display screen 1405 to switch from the screen-off state to the screen-on state.

A person skilled in the art may understand that the structure shown in FIG. 14 does not constitute a limitation on the terminal 1400, and the terminal may include more or fewer components than those shown in the figure, or combine some components, or have different component deployment.

FIG. 15 is a schematic structural diagram of a server according to an embodiment of this application. A server 1500 may vary greatly because of different configurations or performance, and may include one or more central processing units (CPU) 1501 and one or more memories 1502. The memory 1502 stores at least one computer program. The at least one computer program is loaded and executed by the processor 1501 to implement the animation generation method or the motion controller training method provided in the method embodiments. Certainly, the server may further have components such as a wired or wireless network interface, a keyboard, and an input/output interface, to perform input/output. The server may further include other components configured to implement functions of the device. Details are not described herein.

An embodiment of this application further provides a computer-readable storage medium. The computer-readable storage medium stores at least one computer program. The at least one computer program is loaded and executed by a processor of a terminal to implement operations performed by the terminal in the animation generation method or the motion controller training method according to the foregoing embodiments. For example, the computer-readable storage medium may be a read-only memory (ROM), a random access memory (RAM), a compact disc read-only memory (CD-ROM), a tape, a floppy disk, an optical data storage device, or the like.

Embodiments of this application further provide a computer program product, including a computer program, and the computer program is stored in a computer-readable storage medium. The processor of the terminal reads the computer program from the computer-readable storage medium. The processor executes the computer program, so that the terminal performs the animation generation method or the motion controller training method provided in the foregoing various optional implementations.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The above-mentioned descriptions are merely the optional embodiments of this application, but are not intended to limit this application. Any modification, equivalent replacement, or improvement made without departing from the spirit and principle of this application needs to fall within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. An animation generation method performed by a computer device, the method comprising:
obtaining target information and a first pose of a virtual character in a first picture, the target information comprising an operation on the virtual character and a motion state of the virtual character;
processing the target information and the first pose through a motion controller when the virtual character is in a stand-up state, to obtain motion information of the virtual character, the motion controller being configured to determine subsequent motions of the virtual character;
simulating stand-up motion of the virtual character based on the motion information and the first pose, to obtain a second pose of the virtual character; and
animating the stand-up motion of the virtual character by displaying the second pose of the virtual character in the second picture after the first picture.

2. The method according to claim 1, wherein the obtaining the target information of the virtual character in the first picture comprises:
obtaining, in response to the operation on the virtual character, an expected movement direction and an expected movement speed of the virtual character;
determining a motion state of the virtual character in the first picture based on an expected duration of the stand-up animation and the first picture; and
determining the target information based on the expected movement direction, the expected movement speed, and the motion state.

3. The method according to claim 2, wherein the stand-up state comprises a stand-up progress of the virtual character from lying down to standing up; and the determining a motion state of the virtual character in the first picture based on an expected duration of the stand-up animation and the first picture comprises:
determining a number of frames corresponding to the stand-up animation based on the expected duration of the stand-up animation;
determining a unit progress value based on the number of frames and an initial value of the stand-up progress of the virtual character, the initial value being configured for representing the stand-up state of the virtual character in the first picture frame of the stand-up animation and the unit progress value being configured for representing a difference in the stand-up progress of the virtual character between two adjacent picture frames, the two adjacent picture frames being any two adjacent picture frames in the stand-up animation; and
determining the motion state of the virtual character in the first picture based on the initial value, the unit progress value, and a time sequence of the first picture in the stand-up animation.

4. The method according to claim 1, wherein the obtaining the first pose of the virtual character in the first picture comprises:
obtaining angle values of a plurality of rotatable joints on the virtual character; and
determining the first pose of the virtual character based on the angle values of the plurality of rotatable joints, a position vector of a pelvis of the virtual character, and a pose vector of the pelvis.

5. The method according to claim 1, wherein the processing the target information and the first pose through the motion controller when the virtual character is in the stand-up state, to obtain motion information of the virtual character comprises:
concatenating a feature vector of the first pose and a feature vector of the target information through the motion controller, to obtain a character feature vector; and
determining the motion information of the virtual character based on the motion controller and the character feature vector.

6. The method according to claim 1, wherein the determining the motion information of the virtual character based on the motion controller and the character feature vector comprises:
processing the character feature vector through the motion controller, to obtain initial motion information; and
performing Gaussian distribution sampling with the initial motion information as a mean and a preset value as a standard deviation, to obtain the motion information.

7. The method according to claim 1, further comprising:
determining, when the virtual character is in the walking/running state, based on a position of a pelvis of the virtual character and an angle of the pelvis, whether the virtual character satisfies a balance condition; and
updating the motion state of the virtual character from the walking/running state to the stand-up state when the virtual character does not satisfy the balance condition; or
maintaining the motion state of the virtual character as the walking/running state when the virtual character satisfies the balance condition.

8. A computer device, comprising a processor and a memory, the memory being configured for storing at least one computer program, the at least one computer program being executed by the processor and causing the computer device to perform an animation generation method including:
obtaining target information and a first pose of a virtual character in a first picture, the target information comprising an operation on the virtual character and a motion state of the virtual character;
processing the target information and the first pose through a motion controller when the virtual character is in a stand-up state, to obtain motion information of the virtual character, the motion controller being configured to determine subsequent motions of the virtual character;
simulating stand-up motion of the virtual character based on the motion information and the first pose, to obtain a second pose of the virtual character; and
animating the stand-up motion of the virtual character by displaying the second pose of the virtual character in the second picture after the first picture.

9. The computer device according to claim 8, wherein the obtaining the target information of the virtual character in the first picture comprises:
obtaining, in response to the operation on the virtual character, an expected movement direction and an expected movement speed of the virtual character;
determining a motion state of the virtual character in the first picture based on an expected duration of the stand-up animation and the first picture; and
determining the target information based on the expected movement direction, the expected movement speed, and the motion state.

10. The computer device according to claim 9, wherein the stand-up state comprises a stand-up progress of the virtual character from lying down to standing up; and the determining a motion state of the virtual character in the first picture based on an expected duration of the stand-up animation and the first picture comprises:
determining a number of frames corresponding to the stand-up animation based on the expected duration of the stand-up animation;
determining a unit progress value based on the number of frames and an initial value of the stand-up progress of the virtual character, the initial value being configured for representing the stand-up state of the virtual character in the first picture frame of the stand-up animation and the unit progress value being configured for representing a difference in the stand-up progress of the virtual character between two adjacent picture frames, the two adjacent picture frames being any two adjacent picture frames in the stand-up animation; and
determining the motion state of the virtual character in the first picture based on the initial value, the unit progress value, and a time sequence of the first picture in the stand-up animation.

11. The computer device according to claim 8, wherein the obtaining the first pose of the virtual character in the first picture comprises:
obtaining angle values of a plurality of rotatable joints on the virtual character; and
determining the first pose of the virtual character based on the angle values of the plurality of rotatable joints, a position vector of a pelvis of the virtual character, and a pose vector of the pelvis.

12. The computer device according to claim 8, wherein the processing the target information and the first pose through the motion controller when the virtual character is in the stand-up state, to obtain motion information of the virtual character comprises:
concatenating a feature vector of the first pose and a feature vector of the target information through the motion controller, to obtain a character feature vector; and
determining the motion information of the virtual character based on the motion controller and the character feature vector.

13. The computer device according to claim 8, wherein the determining the motion information of the virtual character based on the motion controller and the character feature vector comprises:
processing the character feature vector through the motion controller, to obtain initial motion information; and
performing Gaussian distribution sampling with the initial motion information as a mean and a preset value as a standard deviation, to obtain the motion information.

14. The computer device according to claim 8, wherein the method further comprises:
determining, when the virtual character is in the walking/running state, based on a position of a pelvis of the virtual character and an angle of the pelvis, whether the virtual character satisfies a balance condition; and
updating the motion state of the virtual character from the walking/running state to the stand-up state when the virtual character does not satisfy the balance condition; or
maintaining the motion state of the virtual character as the walking/running state when the virtual character satisfies the balance condition.

15. A non-transitory computer-readable storage medium, configured to store at least one computer program, the at least one computer program, when executed by the computer device, being configured to perform an animation generation method including:
obtaining target information and a first pose of a virtual character in a first picture, the target information comprising an operation on the virtual character and a motion state of the virtual character;
processing the target information and the first pose through a motion controller when the virtual character is in a stand-up state, to obtain motion information of the virtual character, the motion controller being configured to determine subsequent motions of the virtual character;
simulating stand-up motion of the virtual character based on the motion information and the first pose, to obtain a second pose of the virtual character; and
animating the stand-up motion of the virtual character by displaying the second pose of the virtual character in the second picture after the first picture.

16. The non-transitory computer-readable storage medium according to claim 15, wherein the obtaining the target information of the virtual character in the first picture comprises:
obtaining, in response to the operation on the virtual character, an expected movement direction and an expected movement speed of the virtual character;
determining a motion state of the virtual character in the first picture based on an expected duration of the stand-up animation and the first picture; and
determining the target information based on the expected movement direction, the expected movement speed, and the motion state.

17. The non-transitory computer-readable storage medium according to claim 15, wherein the obtaining the first pose of the virtual character in the first picture comprises:
obtaining angle values of a plurality of rotatable joints on the virtual character; and
determining the first pose of the virtual character based on the angle values of the plurality of rotatable joints, a position vector of a pelvis of the virtual character, and a pose vector of the pelvis.

18. The non-transitory computer-readable storage medium according to claim 15, wherein the processing the target information and the first pose through the motion controller when the virtual character is in the stand-up state, to obtain motion information of the virtual character comprises:
concatenating a feature vector of the first pose and a feature vector of the target information through the motion controller, to obtain a character feature vector; and
determining the motion information of the virtual character based on the motion controller and the character feature vector.

19. The non-transitory computer-readable storage medium according to claim 15, wherein the determining the motion information of the virtual character based on the motion controller and the character feature vector comprises:
processing the character feature vector through the motion controller, to obtain initial motion information; and
performing Gaussian distribution sampling with the initial motion information as a mean and a preset value as a standard deviation, to obtain the motion information.

20. The non-transitory computer-readable storage medium according to claim 15, wherein the method further comprises:
determining, when the virtual character is in the walking/running state, based on a position of a pelvis of the virtual character and an angle of the pelvis, whether the virtual character satisfies a balance condition; and
updating the motion state of the virtual character from the walking/running state to the stand-up state when the virtual character does not satisfy the balance condition; or
maintaining the motion state of the virtual character as the walking/running state when the virtual character satisfies the balance condition.
